(19) United States
(12) Patent Application Publication
(10) Pub. No.: US 2012/0133878 A1
(43) Pub. Date: May 31, 2012

(54) LIQUID CRYSTAL DISPLAY DEVICE

(75) Inventor: Yoshiharu HIRAKATA, Ebina (JP)

(73) Assignee: SEMICONDUCTOR ENERGY LABORATORY CO., LTD., Atsugi-shi (JP)

(21) Appl. No.: 13/303,180

(22) Filed: Nov. 23, 2011

(30) Foreign Application Priority Data
Nov. 30, 2010 (JP) 2010-267596

(51) Int. Cl. G02F 1/1343

(52) U.S. Cl. 349/141

(57) ABSTRACT

The intensity of the lateral electric field is enhanced and a reduction of the contrast ratio is suppressed. A liquid crystal display device is provided in which a first substrate and a second substrate with a liquid crystal layer exhibiting a blue phase provided therebetween; a transistor, a first pixel electrode, and a first common electrode which are provided over the first substrate; and a second pixel electrode and a second common electrode which are provided on the second substrate are provided. The first pixel electrode is electrically connected to the transistor and the second pixel electrode.

### TECHNICAL FIELD

One embodiment of the present invention relates to a liquid crystal display device and a manufacturing method thereof.

### BACKGROUND ART

A wide variety of liquid crystal display devices ranging from a large display device such as a television receiver to a small display device such as a mobile phone have been spreading. In recent years, for high image quality and high added values, a liquid crystal material exhibiting a blue phase (hereinafter referred to as a blue-phase liquid crystal) has attracted attention. Blue-phase liquid crystal responds to electric field much faster than other conventional liquid crystal materials, and has been studied for application to liquid crystal display devices that need to be driven with a high frame frequency in order to display 3D images (three-dimensional images), or the like (see Patent Document 1).

As the method for driving the above-described blue-phase liquid crystal, a method has been employed in which a lateral electric field is generated between a pixel electrode and a common electrode which are provided over the same substrate and liquid crystal molecules are driven by the lateral electric field (see Patent Documents 1 and 2). In this specification, the lateral electric field means an electric field applied between the pixel electrode and the common electrode, and refers to an electric field applied in the direction in parallel to the substrate surface. Further, an electric field applied in the direction vertical to the substrate surface is referred to as a vertical electric field in this specification.

### REFERENCE

Patent Document 1: Japanese Published Patent Application No. 2007-271839
Patent Document 2: Japanese Published Patent Application No. 2005-227760

### DISCLOSURE OF INVENTION

In Patent Documents 1 and 2, one of the pixel electrode and the common electrode is provided over a convex structural body in order to reduce the driving voltage. According to such a structure in which one of the pixel electrode and the common electrode is provided over the convex structural body, i.e., on the top surface side of the convex structural body, the intensity of the lateral electric field is increased, so that the driving voltage can be decreased.

However, such a structure in which the convex structural body is provided in a region where the lateral electric field is generated leads to leakage of light due to disorder of the liquid-crystal molecule orientation between the convex structural body and the liquid crystal, the taper angle of the convex structural body, the difference of the refractive index between a material of the convex structural body and a material of the pixel electrode, the difference of the refractive index between a material of the convex structural body and a material of the common electrode, and the like.

Further, in the case where the convex structural body is formed of a dielectric material and the convex structural bodies are disposed at intervals, optical phase may be deviated between light which passes through the portion where the convex structural body exits and light which passes through the portion where the convex structural body does not exit, so that the polarization state of output light may be changed, which may be accompanied by leakage of light. In that case, the adverse effect increases as the height of the convex structural body gets higher.

Further, in the case where the convex structural body is formed of a non-light-transmissive conductor such as metal, or in the case where the pixel electrode or the common electrode itself is formed of convex metal, since convex metals are regularly disposed, a polarization action occurs optically depending on the electrode width, electrode interval, or electrode thickness. Such an optical polarization action leads to leakage of light in the liquid crystal display device, resulting in a reduction in the contrast ratio.

In view of the above, it is an object of one embodiment of the present invention to reduce the driving voltage and suppress a reduction of the contrast ratio in a liquid crystal display device using a liquid crystal layer exhibiting a blue phase.

In an active matrix liquid crystal display device in which a liquid crystal layer exhibiting a blue phase is sandwiched between a first substrate and a second substrate and a plurality of pixels are arranged in a matrix manner, a transistor and a liquid crystal element including a pixel electrode, a liquid crystal layer, and a common electrode are provided for each pixel.

The pixel electrode and the common electrode can have various opening patterns (slits) and have a flat plate-like shape including a bent portion or a branching comb-like shape. For example, the pixel electrode and the common electrode each can have a comb-like pattern. In that case, the pixel electrode and the common electrode can be provided such that their comb-like patterns interlock with each other.

In one embodiment of the present invention, a pixel electrode and a common electrode are provided on both a first substrate side and a counter substrate (second substrate) side. A first pixel electrode on the first substrate side and a second pixel electrode on the second substrate side have the same shape in planar view and are overlap with each other with a liquid crystal layer provided therebetween, and a first common electrode on the first substrate side and a second common electrode on the second substrate side have the same shape in planar view and are overlap with each other with a liquid crystal layer provided therebetween.

The intensity of the lateral electric field weakens as the distance from the electrode in the height direction (direction vertical to the substrate surface) gets larger. For example, the intensity of the lateral electric field formed between the first pixel electrode and the first common electrode is high in a region which is close to the first substrate, and gets lower as the distance from the first substrate in the height direction increases, i.e., toward the second substrate.

Thus, the second pixel electrode and the second common electrode are provided on the second substrate side, whereby the lateral electric field is also formed between these electrodes.

Accordingly, even if the intensity of the lateral electric field formed between the first pixel electrode and the first common electrode weakens as the distance in the height direction increases (toward the second substrate), owing to the lateral electric field formed between the second pixel electrode and the second common electrode, the lateral electric field can be formed evenly over a wide region between the pixel electrodes and the common electrodes provided for these substrates.

That is, an electric field can be applied evenly and effectively to the liquid crystal layer provided between the substrates in the direction which is vertical to the substrate surface. Accordingly, a change of birefringence can be used effectively. In this manner, the driving voltage for driving the liquid crystal layer can be reduced.

In one embodiment of the present invention, a convex structural body is not formed either under a pixel electrode or a common electrode, by which a lateral electric field is formed, so that an unnecessary modulation component with respect to light passing through the lateral electric field is not brought. According to this structure, less light leaks in a black state. In this manner, a reduction in the contrast ratio can be suppressed.

Further, in one embodiment of the present invention, the first pixel electrode is electrically connected to the second pixel electrode. Accordingly, the first pixel electrode and the second pixel electrode can be driven by one transistor, leading to a reduction in power consumption of the liquid crystal display device.

Since the number of transistors for driving the first pixel electrode and the second pixel electrode is one for each pixel as described above, the number of manufacturing steps can be reduced as compared to the case where the first pixel electrode and the second pixel electrode are driven separately. Accordingly, the number of manufacturing steps of the liquid crystal display device can be reduced, so that manufacturing costs can be reduced.

Further, the first common electrode can be electrically connected to the second common electrode, similarly to the pixel electrodes, so that electrical resistance of the first common electrode and the second common electrode can be reduced, reading to a reduction in the driving voltage. Accordingly, power consumption of the liquid crystal display device can be reduced.

One embodiment of the present invention relates to a liquid crystal display device including: a first substrate and a second substrate with a liquid crystal layer exhibiting a blue phase provided therebetween; a transistor, a first pixel electrode, and a first common electrode which are provided over the first substrate; and a second pixel electrode and a second common electrode which are provided on the second substrate. The first pixel electrode is electrically connected to the transistor and the second pixel electrode.

One embodiment of the present invention relates to a liquid crystal display device including: a first substrate and a second substrate with a liquid crystal layer exhibiting a blue phase provided therebetween; a transistor, a first pixel electrode, and a first common electrode which are provided over the first substrate; and a second pixel electrode and a second common electrode which are provided on the second substrate. The first pixel electrode is electrically connected to the transistor and the second pixel electrode. The first common electrode is electrically connected to the second common electrode.

According to one embodiment of the present invention, a convex structural body which serves as a spacer is provided between the first substrate and the second substrate, and part of the first pixel electrode which covers the convex structural body is in contact with part of the second pixel electrode, whereby the first pixel electrode is electrically connected to the second pixel electrode.

According to one embodiment of the present invention, a light-blocking layer is provided over the first substrate, and the convex structural body is provided so as to overlap with the light-blocking layer.

According to one embodiment of the present invention, a convex structural body which serves as a spacer is provided between the first substrate and the second substrate, and part of the second pixel electrode which covers the convex structural body is in contact with part of the first pixel electrode, whereby the first pixel electrode is electrically connected to the second pixel electrode.

According to one embodiment of the present invention, a light-blocking layer is provided over the first substrate, and the convex structural body is provided so as to overlap with the light-blocking layer.

According to one embodiment of the present invention, a convex structural body which serves as a spacer is provided between the first substrate and the second substrate, and part of the first common electrode which covers the convex structural body is in contact with part of the second common electrode, whereby the first common electrode is electrically connected to the second common electrode.

According to one embodiment of the present invention, a light-blocking layer is provided over the first substrate, and the convex structural body is provided so as to overlap with the light-blocking layer.

According to one embodiment of the present invention, a convex structural body which serves as a spacer is provided between the first substrate and the second substrate, and part of the second common electrode which covers the convex structural body is in contact with part of the first common electrode, whereby the first common electrode is electrically connected to the second common electrode.

According to one embodiment of the present invention, a light-blocking layer is provided over the first substrate, and the convex structural body is provided so as to overlap with the light-blocking layer.

According to one embodiment of the present invention, a first convex structural body and a second convex structural body which serve as spacers are provided between the first substrate and the second substrate, and part of the first pixel electrode which covers the first convex structural body is in contact with part of the second pixel electrode which covers the second convex structural body, whereby the first pixel electrode is electrically connected to the second pixel electrode.

According to one embodiment of the present invention, a light-blocking layer is provided over the first substrate, and the first convex structural body and the second convex structural body are provided so as to overlap with the light-blocking layer.

According to one embodiment of the present invention, a third convex structural body and a fourth convex structural body which serve as spacers are provided between the first substrate and the second substrate, and part of the first common electrode which covers the third convex structural body is in contact with part of the second common electrode which covers the fourth convex structural body, whereby the first common electrode is electrically connected to the second common electrode.

According to one embodiment of the present invention, a light-blocking layer is provided over the first substrate, and the third convex structural body and the fourth convex structural body are provided so as to overlap with the light-blocking layer.

According to one embodiment of the present invention, the first pixel electrode, the second pixel electrode, the first common electrode, and the second common electrode have a region having a comb-like shape.

According to one embodiment of the present invention, a convex structural body which serves as a spacer is provided between the first substrate and the second substrate. The convex structural body extends in the direction in which the region having the comb-like shape extends, and part of the first pixel electrode which covers the convex structural body is in contact with part of the second pixel electrode, whereby the first pixel electrode is electrically connected to the second pixel electrode.

According to one embodiment of the present invention, a light-blocking layer is provided over the first substrate, and the convex structural body is provided so as to overlap with the light-blocking layer.

According to one embodiment of the present invention, a convex structural body which serves as a spacer is provided between the first substrate and the second substrate. The convex structural body extends in the direction in which the region having the comb-like shape extends, and part of the second pixel electrode which covers the convex structural body is in contact with part of the first pixel electrode, whereby the first pixel electrode is electrically connected to the second pixel electrode.

According to one embodiment of the present invention, a light-blocking layer is provided over the first substrate, and the convex structural body is provided so as to overlap with the light-blocking layer.

According to one embodiment of the present invention, a convex structural body which serves as a spacer is provided between the first substrate and the second substrate. The convex structural body extends in the direction in which the region having the comb-like shape extends, and part of the first common electrode which covers the convex structural body is in contact with part of the second common electrode, whereby the first common electrode is electrically connected to the second common electrode.

According to one embodiment of the present invention, a light-blocking layer is provided over the first substrate, and the convex structural body is provided so as to overlap with the light-blocking layer.

According to one embodiment of the present invention, a convex structural body which serves as a spacer is provided between the first substrate and the second substrate. The convex structural body extends in the direction in which the region having the comb-like shape extends, and part of the second common electrode which covers the convex structural body is in contact with part of the first common electrode, whereby the first common electrode is electrically connected to the second common electrode.

According to one embodiment of the present invention, a light-blocking layer is provided over the first substrate, and the convex structural body is provided so as to overlap with the light-blocking layer.

Note that the ordinal numbers such as “first” and “second” are used for convenience and do not denote either the order of manufacturing steps or the stacking order of layers. In addition, the ordinal numbers in this specification do not denote particular names which specify the present invention.

According to one embodiment of the present invention, the driving voltage can be reduced and a reduction of the contrast ratio can be suppressed in a liquid crystal display device using a liquid crystal phase exhibiting a blue phase.

### BRIEF DESCRIPTION OF DRAWINGS

In the following accompanying drawings:

FIGS. 1A and 1B are top views of a liquid crystal display device;

FIG. 2 is a cross-sectional view of a liquid crystal display device;

FIG. 3 is a cross-sectional view of a liquid crystal display device;

FIGS. 4A to 4C are cross-sectional views illustrating steps for manufacturing a liquid crystal display device;

FIGS. 5A and 5B are cross-sectional views illustrating steps for manufacturing a liquid crystal display device;

FIGS. 6A and 6B are cross-sectional views illustrating steps for manufacturing a liquid crystal display device;

FIGS. 7A and 7B are top views of a liquid crystal display device;

FIG. 8 is a cross-sectional view of a liquid crystal display device;

FIGS. 9A and 9B are top views of a liquid crystal display device;

FIG. 10 is a cross-sectional view of a liquid crystal display device;

FIGS. 11A and 11B are top views of a liquid crystal display device;

FIG. 12 is a cross-sectional view of a liquid crystal display device;

FIGS. 13A and 13B are top views of a liquid crystal display device;

FIGS. 14A and 14B are top views of a liquid crystal display device;

FIGS. 15A and 15B are top views of a liquid crystal display device;

FIGS. 16A and 16B are top views of a liquid crystal display device;

FIGS. 17A and 17B are top views of a liquid crystal display device;

FIG. 18 is a cross-sectional view of a liquid crystal display device;

FIGS. 19A and 19B are top views of a liquid crystal display device;

FIG. 20 is a cross-sectional view of a liquid crystal display device;

FIGS. 21A and 21B are top views of a liquid crystal display device;

FIGS. 22A and 22B are top views of a liquid crystal display device;

FIGS. 23A and 23B are top views of a liquid crystal display device;

FIGS. 24A and 24B are top views of a liquid crystal display device;

FIGS. 25A and 25B are top views of a liquid crystal display device;

FIGS. 26A and 26B are top views of a liquid crystal display device;

FIG. 27 is a cross-sectional view of a liquid crystal display device;

FIGS. 28A and 28B each are a cross-sectional view and a top view of a liquid crystal display device;

FIGS. 29A and 29B are top views of a liquid crystal display device;

FIGS. 30A and 30B are top views of a liquid crystal display device;

FIGS. 31A and 31B are top views of a liquid crystal display device;

FIGS. 32A and 32B are top views of a liquid crystal display device and FIG. 32C is a cross-sectional view thereof;

FIG. 33 is a perspective view of a liquid crystal module;

FIGS. 34A and 34B are a view and a diagram illustrating an example of an electronic appliance;

FIGS. 35A to 35F are views illustrating examples of an electronic appliance;

FIGS. 36A and 36B are top views of a liquid crystal display device;

FIG. 37 is a view illustrating an example of an electronic appliance;

FIGS. 38A and 38B are top views of a liquid crystal display device;

FIGS. 39A and 39B are graphs for describing a liquid crystal exhibiting a blue phase.

### BEST MODE FOR CARRYING OUT THE INVENTION

Embodiments of the present invention disclosed in this specification are hereinafter described with reference to the accompanying drawings. Note that the present invention can be carried out in a variety of modes, and it is easily understood by those skilled in the art that the modes and details of the present invention disclosed in this specification can be changed in various ways without departing from the spirit and scope thereof. Therefore, the present invention is not construed as being limited to the description of the embodiments. In the drawings, the same portions or portions having similar functions are denoted by the same reference numerals, and description thereof is not repeated.

In the present invention disclosed in this specification, a semiconductor device refers to any element or any device which functions utilizing a semiconductor and includes, in its category, an electric device including an electronic circuit, a display device, a light-emitting device, and the like and an electronic appliance equipped with the electric device.

### Embodiment 1

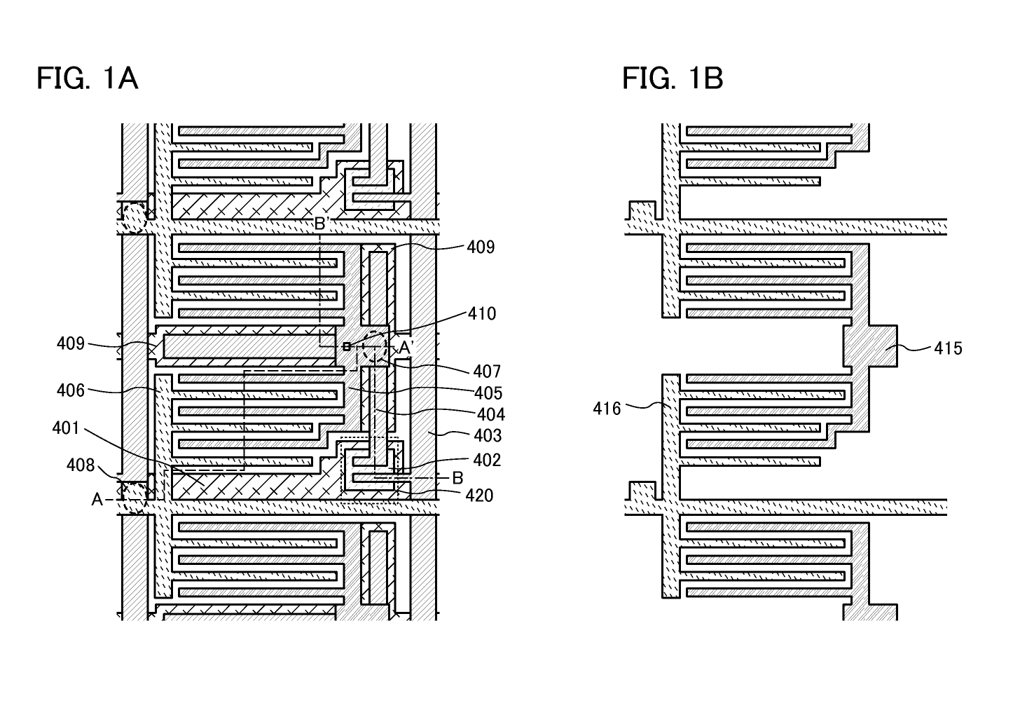

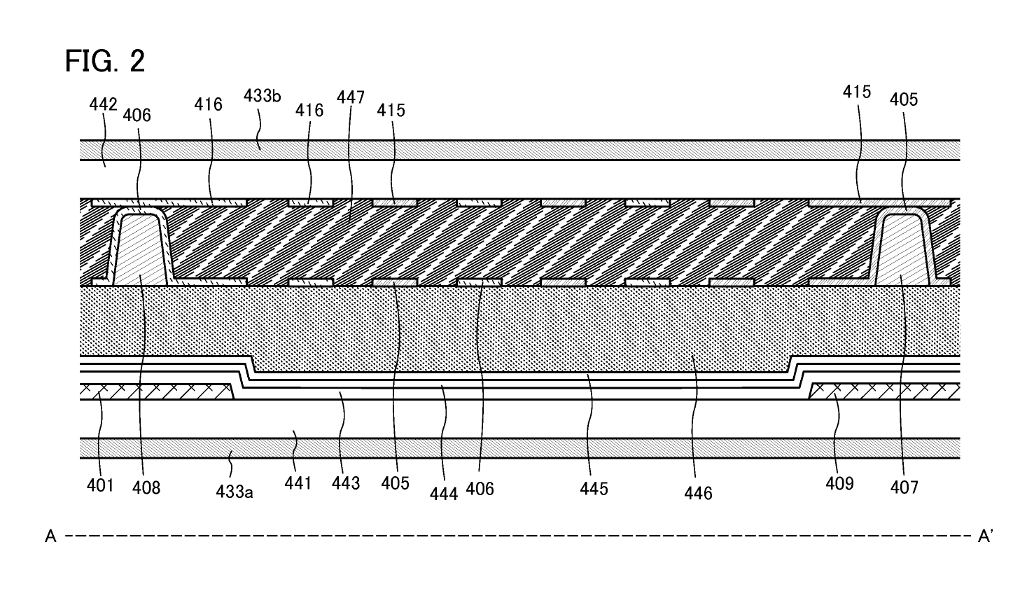

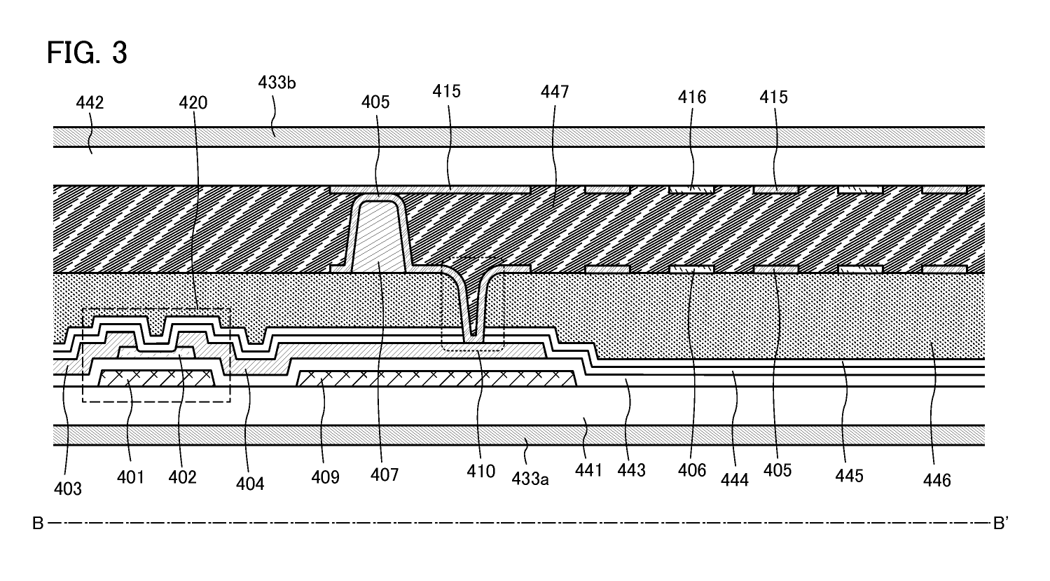

FIG. 1A is a top view on a first substrate side of a liquid crystal display device of this embodiment, and FIG. 1B is a top view on a second substrate side of the liquid crystal display device of this embodiment, each of which illustrates one pixel. FIG. 2 is a cross-sectional view along A-A′ in FIG. 1A, and FIG. 3 is a cross-sectional view along B-B′ in FIG. 1A.

Although electrodes and wirings are provided over a substrate in this embodiment, a top view where the substrate is seen from the side of the electrodes and wirings is shown in FIG. 1A and a top view where the electrodes and wirings are seen from the substrate side is shown in FIG. 1B for clarification of overlap of the electrodes and wirings.

In FIG. 1A, a plurality of wiring layers 403 which function as source wiring layers are provided in parallel to each other (extending in the vertical direction in the drawing) with a space therebetween. A plurality of gate wiring layers 401 (including a gate electrode layer) extend in a direction substantially perpendicular to the wiring layers 403 which function as source wiring layers (the horizontal direction in the drawing) and are provided with a space therebetween.

A capacitor wiring layer 409 extends in the direction parallel to the gate wiring layers 401 and in the direction parallel to the wiring layers 403 which function as source wiring layers. The wiring layer 403 which functions as a source wiring layer, the capacitor wiring layer 409, and the gate wiring layer 401 form a substantially rectangular space, and a pixel electrode 405 that is a first pixel electrode of a liquid crystal display device and a common electrode 406 that is a first common electrode of the same are provided with a liquid crystal layer 447 provided therebetween in that space (see FIG. 2). A transistor 420 for driving the pixel electrode 405 is provided on the bottom-right corner of FIG. 1A. The transistor 420 is provided in a matrix manner for each intersection of the gate wiring layer 401 and the wiring layer 403 which functions as a source wiring layer.

The pixel electrode 405 and the common electrode 406 have various opening patterns (slits) and have a flat plate-like shape including a bent portion or a branching comb-like shape. In that case, the pixel electrode 405 and the common electrode 406 are provided for the same insulating surface (e.g., the same substrate or the same insulating film) such that their comb-like patterns interlock with each other. In the region where their comb-like patterns interlock with each other, the distance between the comb-like pattern of the pixel electrode 405 and the comb-like pattern of the common electrode 406 is preferably greater than or equal to 0.5 μm and less than or equal to 20 μm, still preferably greater than or equal to 1 μm and less than or equal to 5 μm. The above-described range of the distance between the comb-like pattern of the pixel electrode and the comb-like pattern of the common electrode is preferably also applied to this embodiment and other embodiments described below.

FIG. 1B illustrates a pixel electrode 415 that is a second pixel electrode and a common electrode 416 that is a second common electrode on the second substrate side. Like the pixel electrode 405 and the common electrode 406, the pixel electrode 415 and the common electrode 416 are provided for the same insulating surface (e.g., the same substrate or the same insulating film) such that their comb-like patterns interlock with each other. In addition, the pixel electrode 415 and the common electrode 416 have shapes substantially the same as those of the pixel electrode 405 and the common electrode 406 in planar view, respectively. Further, the pixel electrode 405 overlaps with the pixel electrode 415 with the liquid crystal layer 447 provided therebetween, and the common electrode 406 overlaps with the common electrode 416 with the liquid crystal layer 447 provided therebetween.

A first lateral electric field is formed between the pixel electrode 405 that is the first pixel electrode and the common electrode 406 that is the first common electrode. The intensity of the first lateral electric field weakens as the distance in the height direction increases (toward the second substrate 442). A second lateral electric field is formed between the pixel electrode 415 that is the second pixel electrode and the common electrode 416 that is the second common electrode. In this manner, the lateral electric field can be formed evenly over a wide region between the pixel electrodes and the common electrodes.

In this specification, the first pixel electrode and the first common electrode by which the first lateral electric field is formed are provided on the same surface, and the second pixel electrode and the second common electrode by which the second lateral electric field is formed are provided on the same surface. However, they are not necessarily provided on the same surface as long as the first lateral electric field and the second lateral electric field are formed.

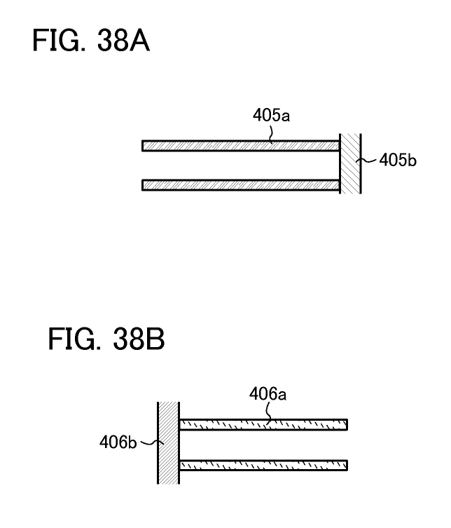

Further, although the pixel electrode 405 and the common electrode 406 are each formed of the same conductive film, an embodiment of the present invention is not limited thereto; the wiring region and the comb-like shape region of the pixel electrode 405 (or the common electrode 406) may be formed of different conductive films. FIG. 38A illustrates one embodiment of the pixel electrode 405 consists of a wiring 405b and a comb-like shape electrode 405a; FIG. 38B illustrates one embodiment of the common electrode 406 consists of a wiring 406b and a comb-like shape electrode 406a. Similarly, any of the pixel electrode 415 and the common electrode 416 may be formed of different conductive films for the wiring region and the comb-like shape region.

The intensity of the lateral electric field in the height direction is enhanced, so that the electric field can be applied evenly and effectively in the direction vertical to the substrate surface.

A convex structural body is not formed either under the pixel electrode 405 and the common electrode 406 where the lateral electric field is formed, or under the pixel electrode 415 and the common electrode 416 where the lateral electric field is formed, so that a reduction in the contrast ratio can be suppressed and the intensity of the lateral electric field can be enhanced.

Further, as shown in FIG. 1A and FIG. 2, a convex structural body (also referred to as a “rib” in this specification) 407 is provided under a region of part of the pixel electrode 405 provided over a first substrate 441. The part of the pixel electrode 405 covers the convex structural body 407. The part of the pixel electrode 405 covering the convex structural body 407 is in contact with part of the pixel electrode 415 provided for a second substrate 442. In this manner, the pixel electrode 405 can be electrically connected to the pixel electrode 415. Accordingly, the pixel electrode 405 and the pixel electrode 415 can be driven not individually but by the transistor 420, which leads to a reduction in power consumption of a liquid crystal display device. In addition, the manufacturing steps of the liquid crystal display device can be decreased to reduce the manufacturing costs.

Similarly, a convex structural body 408 is provided over the first substrate 441 and covered with part of the common electrode 406. The part of the common electrode 406 covering the convex structural body 408 is in contact with part of the common electrode 416 provided for the second substrate 442. In this manner, the common electrode 406 can be electrically connected to the common electrode 416. Accordingly, the resistance of the common electrode 406 and the common electrode 416 can be reduced, which leads to a reduction in driving voltage of the common electrode 406 and the common electrode 416, so that the power consumption of a liquid crystal display device can be reduced.

Note that the common electrode provided for the first substrate 441 is not necessarily in contact with the common electrode provided for the second substrate 442 within a pixel; the common electrode provided for the first substrate 441 may be electrically connected to the common electrode provided for the second substrate 442 outside the pixel. The same can be applied to any other embodiment.

The convex structural body 407 and the convex structural body 408 are provided with a space therebetween so as to sandwich the comb-like shape region of the pixel electrode 405, the comb-like shape region of the common electrode 406, the comb-like shape region of the pixel electrode 415, and the comb-like shape region of the common electrode 416 therebetween. That is, the convex structural bodies 407 and 408 are provided so as not to overlap with either the pixel electrode or the common electrode where the lateral electric field is formed. Accordingly, the convex structural bodies 407 and 408 do not prevent liquid crystal molecules from being oriented in the lateral electric field.

The convex structural body 407 and the convex structural body 408 are provided so as to overlap with the capacitor wiring layer 409 and the gate wiring layer 401, respectively. The capacitor wiring layer 409 and the gate wiring layer 401 block light, so that light does not pass through the convex structural bodies 407 and 408 and the peripheries thereof. Accordingly, an optical polarization action does not occur, so that the contrast ratio of a liquid crystal display device is not decreased.

The convex structural body 407 and the convex structural body 408 are provided so as to overlap with the capacitor wiring layer 409 and the gate wiring layer 401, respectively according to this embodiment, giving such effect that a film for shielding the convex structural bodies 407 and 408 from light needs not to be formed additionally. However, a film for blocking the convex structural bodies 407 and 408 from light may be provided on the second substrate 442 side, if necessary. Further, a film for shielding any other convex structural body from light may be provided not on the substrate side where that convex structural body is provided but on the opposing substrate side, if necessary. The same can be applied to any other embodiment.

As shown in FIG. 1A and FIG. 3, a potential of an image signal is applied to the pixel electrode 405 through the wiring layer 403 or a wiring layer 404 which is electrically connected to a semiconductor layer 402 of the transistor 420. The pixel electrode 415 is supplied with the potential of an image signal through the part of the pixel electrode 405 covering the convex structural body 407 as described above.

On the other hand, the common electrode 406 of a liquid crystal element is applied with a fixed potential (e.g., a ground potential) serving as a reference with respect to the potential of the image signal supplied to the pixel electrode. The common electrode 416 is applied with the fixed potential through the part of the common electrode 406 covering the convex structural body 408.

As shown in FIG. 3, the transistor 420 is an inverted-staggered thin film transistor formed over the first substrate 441 which is a substrate having an insulating surface, and includes the gate wiring layer 401, a gate insulating layer 443, the semiconductor layer 402, the wiring layer 403 serving as one of a source electrode layer and a drain electrode layer, and the wiring layer 404 serving as the other of the source electrode layer and the drain electrode layer.

Over the transistor 420, an insulating film 444 which is in contact with the semiconductor layer 402 and an insulating film 445 are provided, and an insulating layer 446 is stacked over the insulating film 445. The insulating films 444 and 445 and the insulating layer 446 serve as an interlayer insulating film provided between the transistor 420 and the pixel electrode 405 and the common electrode 406.

The insulating film 444, the insulating film 445, and the insulating layer 446 provided between the wiring layer 404 and the pixel electrode 405 are selectively removed to form an opening 410. In this embodiment, an example is described in which the opening 410 reaches the wiring layer 404. The liquid crystal layer 447 is formed so as to fill the opening 410.

The liquid crystal layer 447 is provided over the pixel electrode 405 and the common electrode 406, and sealed with the second substrate 442 that is the counter substrate.

Further, a storage capacitor is formed in a region where the capacitor wiring layer 409 formed using the same material in the same step as those of the gate wiring layer 401, the gate insulating layer 443, and the wiring layer 404 overlap with each other.

The first substrate 441 and the second substrate 442 are light-transmitting substrates and are provided with a polarizing plate 443a and a polarizing plate 443b respectively on their outer sides (the sides opposite from the side where the liquid crystal layer 447 is provided).

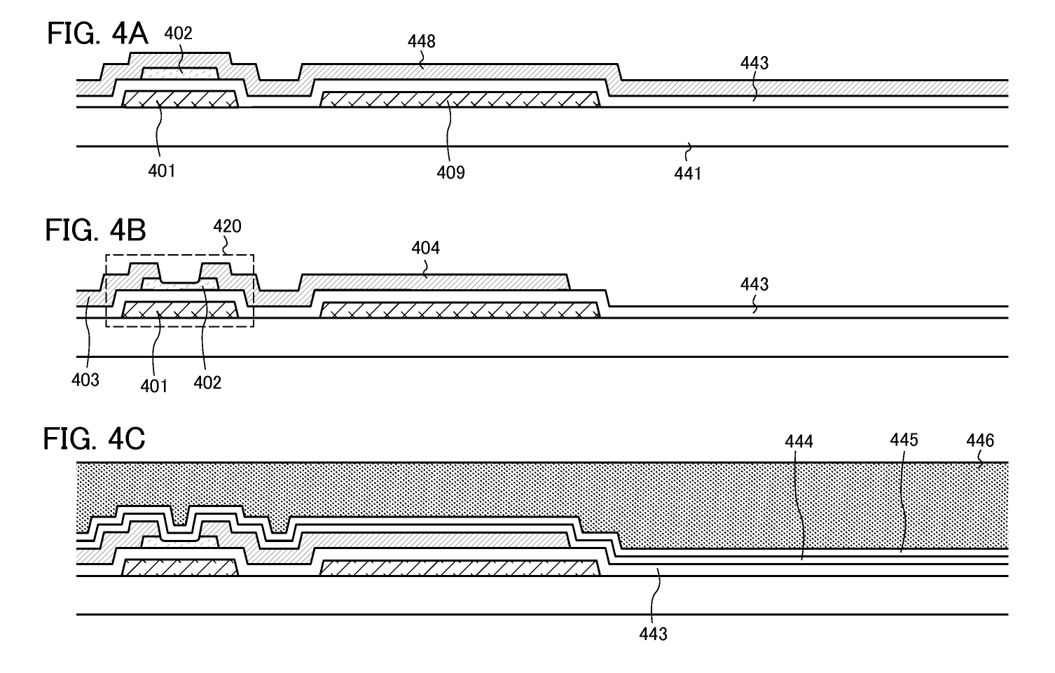

A process for manufacturing the liquid crystal display device shown in FIGS. 1A and 1B is described using FIGS. 4A to 4C, FIGS. 5A and 5B, and FIGS. 6A and 6B. Any of FIGS. 4A to 4C, FIGS. 5A and 5B, and FIGS. 6A and 6B is a cross-sectional view in the manufacturing process of the liquid crystal display device.

In FIG. 4A, the gate wiring layer 401, the capacitor wiring layer 409, the gate insulating layer 443, and the semiconductor layer 402 are formed over the first substrate 441 that is an element substrate, and a conductive film 448 is formed over the gate wiring layer 401, the gate insulating layer 443, and the semiconductor layer 402.

An insulating film serving as a base film may be provided between the first substrate 441 and the gate wiring layer 401. The base film has a function of preventing diffusion of an impurity element from the first substrate 441, and can be formed to have a single-layer structure or a stacked-layer structure using one or more of a silicon nitride film, a silicon oxide film, a silicon nitride oxide film, and a silicon oxynitride film.

The gate wiring layer 401 can be formed to have a single-layer structure or a stacked-layer structure using a metal material such as molybdenum, titanium, chromium, tantalum, tungsten, aluminum, copper, neodymium, or scandium or an alloy material which contains any of these materials as its main component. By using a light-blocking conductive film as the gate wiring layer 401, light from a backlight (light passing through the first substrate 441) can be prevented from entering the semiconductor layer 402. The capacitor wiring layer 409 is formed using the same material in the same step as those of the gate wiring layer 401.

For example, as a two-layer structure of the gate wiring layer 401, the following structure is preferable: a two-layer structure of an aluminum layer and a molybdenum layer stacked thereover, a two-layer structure of a copper layer and a molybdenum layer stacked thereover, a two-layer structure of a copper layer and a titanium nitride layer or a tantalum nitride layer stacked thereover, or a two-layer structure of a titanium nitride layer and a molybdenum layer. As a three-layer stacked structure of the gate wiring layer 401, a three-layer stacked structure in which a tungsten layer or a tungsten nitride layer, an alloy of aluminum and silicon or an alloy of aluminum and titanium, and a titanium nitride layer or a titanium layer are stacked is preferable.

The gate insulating layer 443 can be formed to have a single-layer structure or a stacked-layer structure using a silicon oxide layer, a silicon nitride layer, a silicon oxynitride layer, or a silicon nitride oxide layer by a plasma CVD method, a sputtering method, or the like. The gate insulating layer 443 can be formed of a silicon oxide layer by a CVD method using an organosilane gas. As the organosilane gas, a silicon-containing compound such as tetraethoxysilane (TEOS) (chemical formula: Si(OC₂H₅)₄), tetramethylsilane (TMS) (chemical formula: Si(CH₃)₄), tetramethylcyclotetrasiloxane (TMCTS), octamethylcyclotetrasiloxane (OMCTS), hexamethyldisilazane (HMDS), triethoxysilane (chemical formula: SiH(OC₂H₅)₃), or trisdimethylaminosilane (chemical formula: SiH(N(CH₃)₂)₃) can be used.

As a material of the semiconductor layer 402, the following metal oxide can be used: a four-component metal oxide such as an In—Sn—Ga—Zn—O-based oxide semiconductor; a three-component metal oxide such as an In—Ga—Zn—O-based oxide semiconductor, an In—Sn—Zn—O-based oxide semiconductor, an In—Al—Zn—O-based oxide semiconductor, a Sn—Ga—Zn—O-based oxide semiconductor, an Al—Ga—Zn—O-based oxide semiconductor, or a Sn—Al—Zn—O-based oxide semiconductor; a two-component metal oxide such as an In—Zn—O-based oxide semiconductor, a Sn—Zn—O-based oxide semiconductor, an Al—Zn—O-based oxide semiconductor, a Zn—Mg—O-based oxide semiconductor, a Sn—Mg—O-based oxide semiconductor, an In—Mg—O-based oxide semiconductor, or an In—Ga—O-based oxide semiconductor; an In—O-based oxide semiconductor, a Sn—O-based oxide semiconductor, or a Zn—O-based oxide semiconductor; or the like.

The semiconductor layer 402 may be formed using a microcrystalline semiconductor film, typically a microcrystalline silicon film, a microcrystalline silicon-germanium film, a microcrystalline germanium film, or the like.

As a material of the conductive film 448, an element selected from Al, Cr, Ta, Ti, Mo, or W; an alloy containing any of these elements as its component; an alloy film containing any of these elements in combination; and the like can be given. Further, in the case where heat treatment is performed in the following process, the conductive film preferably has heat resistance against the heat treatment. For example, since use of Al alone brings disadvantages such as poor resistance to heat and a tendency to corrosion, aluminum is used in combination with a conductive material having heat resistance. As the conductive material having heat resistance, which is combined with aluminum, it is possible to use an element selected from titanium (Ti), tantalum (Ta), tungsten (W), molybdenum (Mo), chromium (Cr), neodymium (Nd), and scandium (Sc), an alloy containing any of these elements as its component, an alloy containing a combination of any of these elements, or a nitride containing any of these elements as its component.

The conductive film 448 may be formed using a conductive metal oxide. Examples of the conductive metal oxide are indium oxide (In₂O₃), tin oxide (SnO₂), zinc oxide (ZnO), a mixed oxide of indium oxide and tin oxide (In₂O₃—SnO₂, referred to as ITO: indium tin oxide), a mixed oxide of indium oxide and zinc oxide (In₂O₃—ZnO), and any of these metal oxide materials containing silicon oxide.

The gate insulating layer 443, the semiconductor layer 402, and the conductive film 448 may be successively formed without exposure to air. Such successive formation without exposure to air leads to a formation of each interface of the stacked layers without contamination by atmospheric components or impurity elements floating in air, so that variation in characteristics of the transistor can be reduced.

The conductive film 448 is processed by a photolithography process to form the wiring layer 403 and the wiring layer 404 that are a source and drain wiring layers (see FIG. 4B). In this embodiment, an example is described in which part of the semiconductor layer 402, over which neither the wiring layer 403 nor the wiring layer 404 is provided, is etched in the etching step of the conductive film 448 to have a groove (a depressed portion).

Through the above, the transistor 420 including the gate wiring layer 401, the gate insulating layer 443, the semiconductor layer 402, the wiring layer 403, and the wiring layer 404 is formed.

Over the semiconductor layer 402, the wiring layer 403, the wiring layer 404, and the gate insulating layer 443, the insulating film 444, the insulating film 445, and the insulating layer 446 are stacked (see FIG. 4C).

As any of the insulating films 444 and 445 and the insulating layer 446 which cover the transistor 420, an inorganic insulating film or an organic insulating film which is formed by a dry method or a wet method can be used. For example, any of the insulating films 444 and 445 and the insulating layer 446 may be formed using silicon nitride, silicon oxide, silicon nitride oxide, silicon oxynitride, aluminum nitride, aluminum oxide, aluminum nitride oxide, aluminum oxynitride, or the like by a dry method such as a CVD method or a sputtering method, or may be formed using an organic material such as polyimide, acrylic, benzocyclobutene, polyamide, or epoxy by a wet method such as spin coating, dipping, spray coating, a droplet discharge method (e.g., an inkjet method, screen printing, or offset printing) or with a tool such as a roll coater, a curtain coater, or a knife coater. Other than such organic materials, a low-dielectric constant material (a low-k material), a siloxane-based resin, PSG (phosphosilicate glass), BPSG (borophosphosilicate glass), or the like can be used as well.

The siloxane-based resin corresponds to a resin including a Si—O—Si bond formed using a siloxane-based material as a starting material. The siloxane-based resin may have as a substituent an organic group (e.g., an alkyl group or an aryl group) or a fluoro group. In addition, the organic group may have a fluoro group. A siloxane-based resin can be applied by a coating method and baked to form the insulating layer 446.

Any of the insulating films 444 and 445 may be formed by stacking a plurality of insulating films formed using any of these materials. For example, such a structure that an organic resin film is stacked over an inorganic insulating film may be employed.

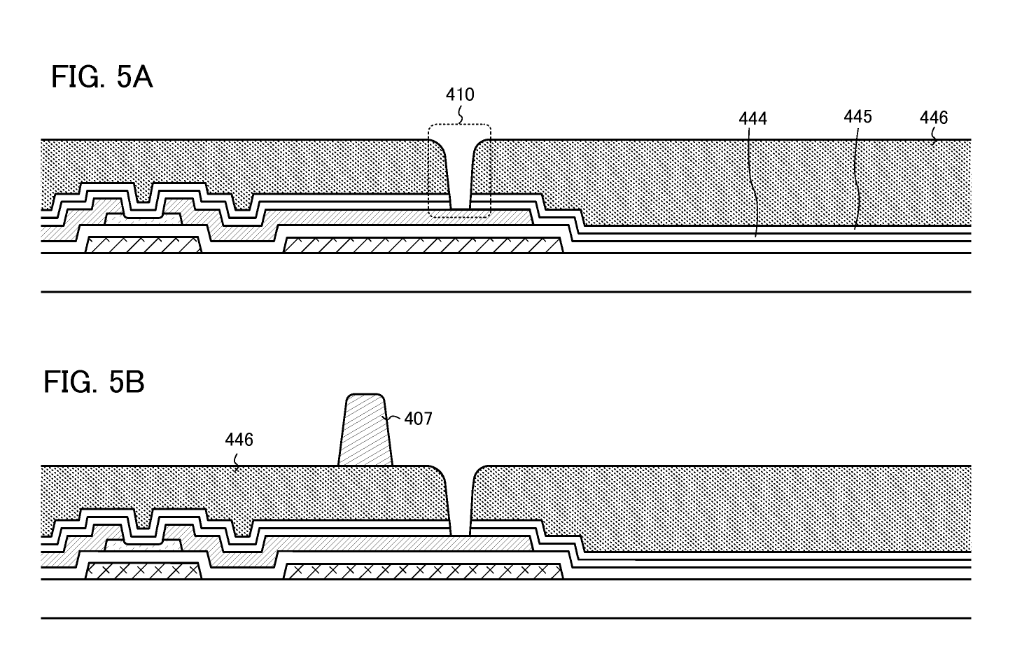

Next, the opening (contact hole) 410 reaching the wiring layer 404 is formed in the insulating film 444, the insulating film 445, and the insulating layer 446 (see FIG. 5A).

The convex structural body 407 is formed over the insulating film 446 (see FIG. 5B). In the same step as the above, the convex structural body 408 is also formed over the insulating film 446, though not shown in FIG. 5B. The convex structural bodies 407 and 408 each have a domical shape which is a substantially semicircular shape and has a rounded top. Such a structural body having a curved surface enables the pixel electrode 405 and the common electrode 406 to be stacked thereover to have favorable shapes with high coverage.

Although an example is described in this embodiment in which the convex structural body 407 is formed after the opening 410 is formed, the order of manufacturing steps in one embodiment of the present invention is not limited thereto. The opening 410 may be formed after the convex structural bodies 407 and 408 are formed over the insulating layer 446.

Any of the convex structural bodies 407 and 408 may be formed to have a single-layer structure or a stacked-layer structure using an insulator such as an inorganic insulating layer or an organic resin layer. Further or alternatively, the convex structural bodies 407 and 408 may be formed using a metal film. In that case, the pixel electrode 405 and the common electrode 406 are not necessarily formed over the convex structural body 407 and the convex structural body 408.

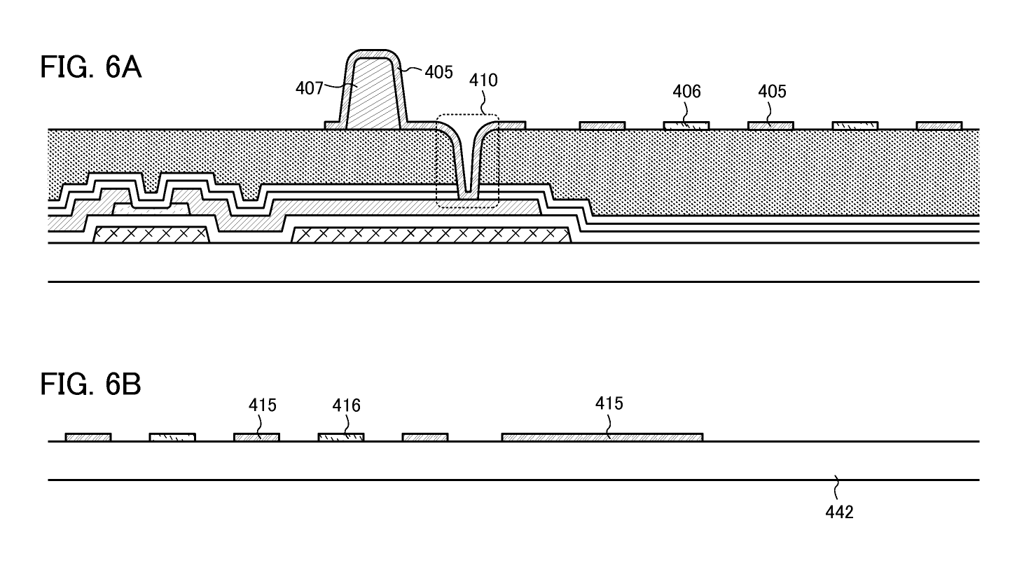

Next, a conductive film is formed over the opening 410, the insulating layer 446, and the convex structural body 407. The conductive film is processed by a photolithography process to form the pixel electrode 405 which is electrically connected to the wiring layer 404 and the common electrode 406 (see FIG. 6A). The common electrode 406 is formed over the convex structural body 408, though not shown in FIG. 6A. As described above, in the case where a metal film is used as a material of each of the convex structural bodies 407 and 408, the pixel electrode 405 and the common electrode 406 are not necessarily formed over the convex structural body 407 and the convex structural body 408.

The pixel electrode 405 and the common electrode 406 can be formed using a light-transmitting conductive material such as indium oxide containing tungsten oxide, indium zinc oxide containing tungsten oxide, indium oxide containing titanium oxide, indium tin oxide containing titanium oxide, indium tin oxide (hereinafter referred to as ITO), indium zinc oxide, or indium tin oxide to which silicon oxide is added.

The pixel electrode 405 and the common electrode 406 can also be formed using a conductive composition including a conductive high molecule (also referred to as a conductive polymer). As for the conductive composition as a material of any of the pixel electrode 405 and the common electrode 406, it is preferable that the sheet resistance is 10000 W/square or less and the light transmittance at a wavelength of 550 nm is 70% or more. Further, the resistivity of the conductive high molecule included in the conductive composition is preferably 0.1Ω·cm or less.

As the conductive high molecule, a so-called π-electron conjugated conductive polymer can be used. For example, polyaniline or a derivative thereof, polypyrrole or a derivative thereof, polythiophene or a derivative thereof, a copolymer of two or more of aniline, pyrrole, and thiophene or a derivative thereof, and the like can be given.

In the same step as the step for forming the pixel electrode 405 and the common electrode 406 over the first substrate 441, the pixel electrode 415 and the common electrode 416 are formed over the second substrate 442 (see FIG. 6B). The pixel electrode 415 has the same shape as the pixel electrode 405 in planar view, and is provided so as to overlap with the pixel electrode 405. Similarly, the common electrode 416 has the same shape as the common electrode 406 in planar view, and is provided so as to overlap with the common electrode 406.

The first substrate 441 and the second substrate 442 that is the counter substrate are firmly attached to each other by a sealant with the liquid crystal layer 447 provided therebetween. The liquid crystal layer 447 can be formed by a dispenser method (a dropping method), or an injection method by which liquid crystal is injected using a capillary phenomenon or the like after the first substrate 441 is attached to the second substrate 442. The thickness of the liquid crystal layer 447 is preferably greater than or equal to 1 μm and less than or equal to 20 μm. The height of the convex structural body in this embodiment may be set such that the thickness of the liquid crystal layer 447 is greater than or equal to 1 μm and less than or equal to 20 μm

A liquid crystal material exhibiting a blue phase is used for the liquid crystal layer 447.

The liquid crystal material exhibiting a blue phase includes a liquid crystal and a chiral agent. The chiral agent is employed to align the liquid crystal in a helical structure and to make the liquid crystal exhibit a blue phase. For example, a liquid crystal material into which a chiral agent is mixed at several weight percent or more may be used for the liquid crystal layer.

As the liquid crystal, a thermotropic liquid crystal, a low-molecular liquid crystal, a high-molecular liquid crystal, a ferroelectric liquid crystal, an anti-ferroelectric liquid crystal, or the like is used.

As the chiral agent, a material having a high compatibility with a liquid crystal and a strong twisting power is used. Further, either one of two enantiomers, R and S, is preferably used, and a racemic mixture in which R and S are contained at 50:50 is not used.

The above liquid crystal material exhibits a cholesteric phase, a cholesteric blue phase, a smectic phase, a smectic blue phase, a cubic phase, a chiral nematic phase, an isotropic phase, or the like depending on conditions.

A cholesteric blue phase and a smectic blue phase, which are blue phases, are exhibited in a liquid crystal material having a cholesteric phase or a smectic phase with a relatively short helical pitch of less than or equal to 500 nm. The orientation of the liquid crystal material has a double twist structure. Having the order of less than or equal to an optical wavelength in the visible wavelength range, the liquid crystal material is transparent, and change the orientation order by voltage application to cause optical modulation action. A blue phase is optically isotropic and thus has no viewing angle dependence. Thus, an alignment film is not necessarily formed; accordingly, display image quality can be improved and manufacturing costs can be reduced.

The blue phase appears only within a narrow temperature range; therefore, it is preferable that a photocurable resin and a photopolymerization initiator be added to a liquid crystal material and polymer stabilization treatment be performed thereon in order to widen the temperature range. The polymer stabilization treatment is performed in such a manner that a liquid crystal material including a liquid crystal, a chiral agent, a photocurable resin, and a photopolymerization initiator is irradiated with light having a wavelength with which the photocurable resin and the photopolymerization initiator are reacted. This polymer stabilization treatment may be performed by irradiating a liquid crystal material in the state of exhibiting an isotropic phase with light or by irradiating a liquid crystal material in the state of exhibiting a blue phase with light under the control of the temperature.

For example, the polymer stabilization treatment is performed in the following manner: the temperature of the liquid crystal layer is adjusted and under the state in which the blue phase is exhibited, the liquid crystal layer is irradiated with light. However, one embodiment of the present is not limited thereto; the polymer stabilization treatment may be performed in such a manner that under the state where the liquid crystal layer exhibits an isotropic phase at a temperature within +10° C., preferably +5° C. from the phase transition temperature between the blue phase and the isotropic phase, the liquid crystal layer is irradiated with light. The phase transition temperature between the blue phase and the isotropic phase is a temperature at which the phase changes from the blue phase to the isotropic phase when the temperature rises, or a temperature at which the phase changes from the isotropic phase to the blue phase when the temperature decreases. As an example of the polymer stabilization treatment, the following method can be employed: the liquid crystal layer is heated to exhibit the isotropic phase, and after that, the temperature of the liquid crystal layer is gradually decreased so that the phase changes to the blue phase, and then, the liquid crystal layer is irradiated with light while the temperature at which the blue phase is exhibited is kept. Alternatively, the following method can be employed: the liquid crystal layer is gradually heated to change the phase to the isotropic phase, and then, the liquid crystal layer is irradiated with light at a temperature within +10° C., preferably +5° C. from the phase transition temperature between the blue phase and the isotropic phase (with an isotropic phase exhibited). In the case of using an ultraviolet curable resin (a UV curable resin) as the photocurable resin included in the liquid crystal material, the liquid crystal layer may be irradiated with ultraviolet rays. Note that, even without exhibition of the blue phase, such polymer stabilization treatment that the liquid crystal layer is irradiated with light at a temperature within +10° C., preferably +5° C. from the phase transition temperature between the blue phase and the isotropic phase (with an isotropic phase exhibited) enables the response rate to be as short as 1 msec or less, which enables high-speed response.

The photocurable resin may be a monofunctional monomer such as acrylate or methacrylate; a polyfunctional monomer such as diacrylate, triacrylate, dimethacrylate, or trimethacrylate; or a mixture thereof. Further, the photocurable resin may have liquid crystallinity, non-liquid crystallinity, or both of them. A resin which is cured with light having a wavelength with which the photopolymerization initiator to be used is reacted may be selected as the photocurable resin; typically, an ultraviolet curable resin can be used.

As the photopolymerization initiator, a radical polymerization initiator which generates radicals by light irradiation, an acid generator which generates an acid by light irradiation, or a base generator which generates a base by light irradiation may be used.

Specifically, a mixture of JC-1041XX (produced by Chisso Corporation) and 4-cyano-4′-pentylbiphenyl can be used as the liquid crystal material. ZLI-4572 (produced by Merck Ltd., Japan) can be used as the chiral agent. As the photocurable resin, 2-ethylhexyl acrylate, RM257 (produced by Merck Ltd., Japan), or trimethylolpropane triacrylate can be used. As the photopolymerization initiator, 2,2-dimethoxy-2-phenylacetophenone can be used.

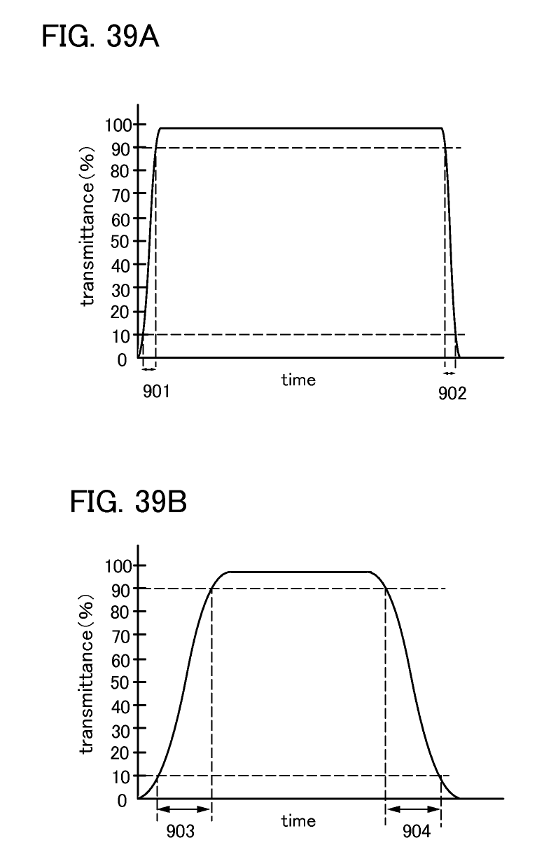

With the liquid crystal exhibiting a blue phase, as show in FIG. 39A, a rising time 901 (time taken for reaching a transmittance of 90% from a transmittance of 10%) and a falling time 902 (time taken for reaching the transmittance of 10% from the transmittance of 90%) can be reduced to 1 millisecond or less. On the other hand, with a liquid crystal of a vertical alignment (VA) mode, which is a conventional example, a rising time 903 and a falling time 904 are longer than the rising time and the falling time of the liquid crystal exhibiting a blue phase and each are several milliseconds or more, as shown in FIG. 39B.

As described above, the response rate of a liquid crystal material exhibiting a blue phase is shorter than that of the conventional liquid crystal material and enables high speed response, leading to a higher performance of a liquid crystal display device using the liquid crystal exhibiting a blue phase.

In this specification, in the case where the liquid crystal display device is a transmissive liquid crystal display device in which display is performed with light from a light source transmitted (or a transflective liquid crystal display device), it is necessary to transmit light at least in a pixel region. Therefore, any of the first substrate, the second substrate, and thin films such as an insulating film and a conductive film that exist in the pixel region through which the light passes has a light-transmitting property with respect to light in the visible wavelength range.

As the sealant, it is preferable to use visible light curable, ultraviolet curable, or heat curable resin, typically. Typically, an acrylic resin, an epoxy resin, an amine resin, or the like can be used. Further, a photopolymerization initiator (typically, an ultraviolet light polymerization initiator), a thermosetting agent, a filler, or a coupling agent may be included in the sealant.

Polymer stabilization treatment is performed on the liquid crystal layer by irradiation with light, so that the liquid crystal layer 447 is formed. The light has a wavelength with which the photocurable resin and the photopolymerization initiator included in the liquid crystal layer are reacted. By this polymer stabilization treatment with light irradiation, the temperature range in which the liquid crystal layer 447 exhibits a blue phase can be widened.

As the liquid crystal layer, a liquid crystal layer which has a vertical alignment at no voltage applied may be used.

In the case where a photocurable resin such as an ultraviolet curable resin is used as the sealant and the liquid crystal layer is formed by a dropping method, for example, the sealant may be cured by the light irradiation step of the polymer stabilization treatment.

A light-blocking layer can be provided so as to cover at least the top surface of the semiconductor layer, by which incident light on the semiconductor layer of the transistor can be blocked, so that electric characteristics of the transistor can be prevented from being varied due to photosensitivity of the semiconductor and can be further stabilized. Further, the light-blocking layer can be provided so as to cover the contact hole and/or a space between the pixels, by which display unevenness caused by light leakage or the like due to an alignment defect of the liquid crystal that is likely to occur on the contact hole can be concealed, so that a reduction in contrast can be suppressed. Thus, high definition and high reliability of the liquid crystal display device can be achieved.

A light-blocking material that reflects or absorbs light is used as the light-blocking layer. For example, a black organic resin can be used, which can be formed by mixing a black resin of a pigment material, carbon black, titanium black, or the like into a resin material such as photosensitive or non-photosensitive polyimide. A light-blocking metal film can be used as well; chromium, molybdenum, nickel, titanium, cobalt, copper, tungsten, aluminum, or the like can be used, for example.

There is no particular limitation on the formation method of the light-blocking layer; a dry method such as a vapor deposition method, a sputtering method, a CVD method, or the like or a wet method such as spin coating, dip coating, spray coating, a droplet discharging method (e.g., an ink jetting method, screen printing, or offset printing), or the like may be used depending on the material, and may be processed into an appropriate pattern by an etching method (dry etching or wet etching) if necessary.

with a structure in which the light-blocking layer is formed on the first substrate 441 side that is the element substrate side, light delivered from the counter substrate (the second substrate 442) side is not absorbed or blocked by the light-blocking layer in the light irradiation step for polymer stabilization; consequently, the entire liquid crystal layer can be uniformly irradiated with light, and the liquid crystal layer can be photopolymerized. Thus, alignment disorder of liquid crystals due to nonuniform photopolymerization, display unevenness accompanied by the alignment disorder, and the like can be prevented.

In this embodiment, the polarizing plate 443a is provided on the outer side (on the side opposite to the liquid crystal layer 447) of the first substrate 441, and the polarizing plate 443b is provided on the outer side (on the side opposite to the liquid crystal layer 447) of the second substrate 442. In addition to the polarizing plate, an optical film such as a retardation plate or an anti-reflection film may be provided. For example, circular polarization by the polarizing plate and the retardation plate may be used. Through the above-described process, a liquid crystal display device can be completed.

In the case of manufacturing a plurality of liquid crystal display devices using a large-sized substrate (a so-called multi-panel technology), the division step can be performed before the polymer stabilization treatment or before provision of the polarizing plates. In consideration of the adverse effect of the division step on the liquid crystal layer (such as alignment disorder due to force applied in the division step), it is preferable that the division step be performed after the attachment between the first substrate and the second substrate before the polymer stabilization treatment.

Although not shown, a backlight, a sidelight, or the like may be used as a light source. Light from the light source is delivered from the first substrate 441 side, which is the element substrate side, to pass through the second substrate 442 on a viewing side.

The liquid crystal material exhibiting a blue phase has a small response rate of 1 msec or less and enables high-speed response, which provides a high performance to the liquid crystal display device.

For example, the liquid crystal material exhibiting a blue phase, which is capable of high-speed response, can be favorably used for a successive additive color mixing method (a field sequential method) in which light-emitting diodes (LEDs) of RGB or the like are arranged in a backlight unit and color display is performed by time division, or a three-dimensional display method using a shutter glasses system in which images on the right side and images on the left side are alternately viewed by time division.

According to this embodiment described above, the driving voltage can be reduced and a reduction of the contrast ratio can be suppressed in a liquid crystal display device using a liquid crystal material exhibiting a blue phase.

### Embodiment 2

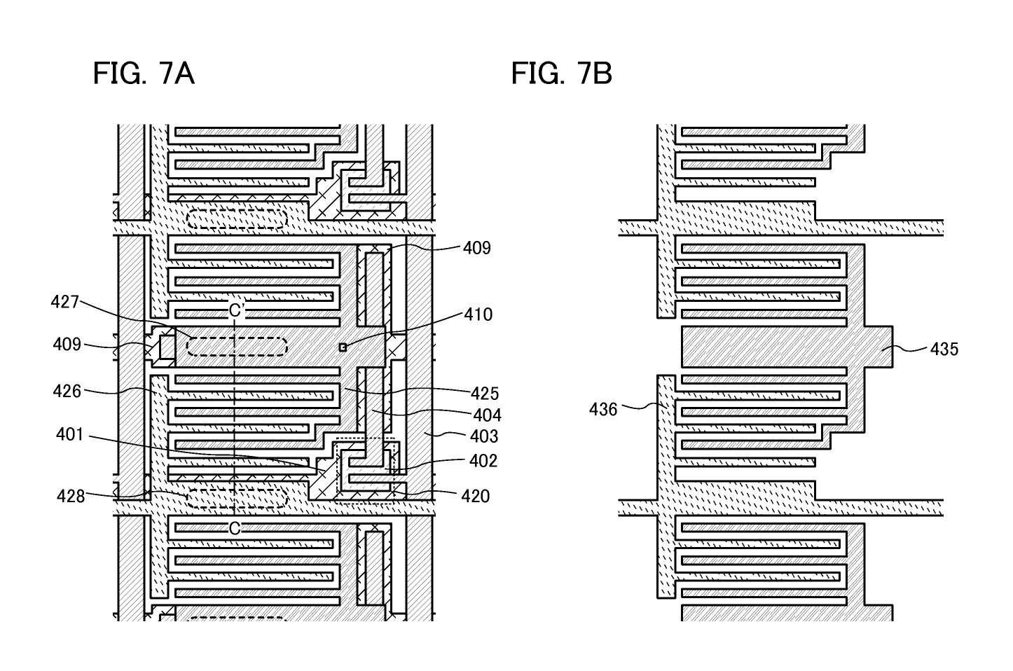

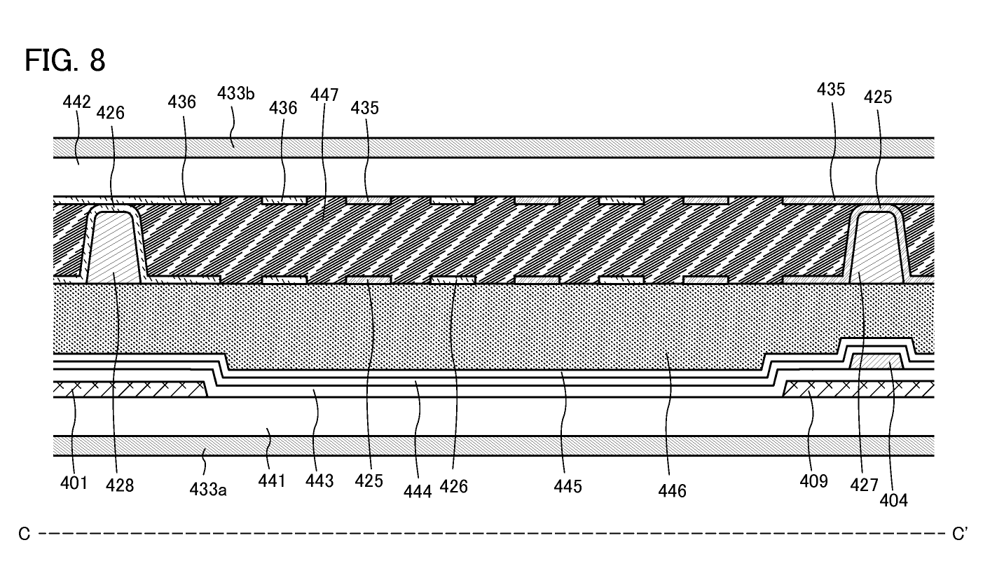

In this embodiment, a liquid crystal display device having a structure different from Embodiment 1 is described using FIGS. 7A and 7B and FIG. 8. The same elements as Embodiment 1 are denoted by the same reference numerals in this embodiment.

FIG. 7A is a top view on a first substrate side of a liquid crystal display device of this embodiment, and FIG. 7B is a top view on a second substrate side of the liquid crystal display device of this embodiment, each of which illustrates one pixel. FIG. 8 is a cross-sectional view along C-C′ in FIG. 7A.

Although electrodes and wirings are provided over a substrate also in this embodiment like the above embodiment, a top view where the substrate is seen from the side of the electrodes and wirings is shown in FIG. 7A and a top view where the electrodes and wirings are seen from the substrate side is shown in FIG. 7B for clarification of overlap of the electrodes and wirings.

A convex structural body 427 and a convex structural body 428 of this embodiment extend in the direction in which a comb-like shape region of a pixel electrode 425 and a comb-like shape region of a common electrode 426 extend. Thus, part of the pixel electrode 425 which covers the convex structural body 427 and part of the common electrode 426 which covers the convex structural body 428 also extend in the direction in which the comb-like shape region of the pixel electrode 425 and the comb-like shape region of the common electrode 426 extend.

With the above-described arrangement of the convex structural bodies 427 and 428, the intensity of the lateral electric field can be enhanced by the part of the pixel electrode 425 which covers the convex structural body 427 and the part of the common electrode 426 which covers the convex structural body 428. That is, the part of the pixel electrode 425 and the part of the common electrode 426 exist in the height direction (film thickness direction) of the liquid crystal layer 447, so that the lateral electric field is formed widely also in the height direction (film thickness direction), whereby the lateral electric field can be formed evenly over a wide region between the pixel electrode and the common electrode.

The convex structural body 427 and the convex structural body 428 are provided so as to overlap with the capacitor wiring layer 409 and the gate wiring layer 401, respectively. The capacitor wiring layer 409 and the gate wiring layer 401 block light, so that light does not pass through the convex structural bodies 407 and 408 and the peripheral portions thereof. Accordingly, an optical polarization action does not occur, so that the contrast ratio of a liquid crystal display device is not decreased.

Further, like Embodiment 1, the part of the pixel electrode 425 covering the convex structural body 427 is in contact with part of a pixel electrode 435 provided for the second substrate 442. In this manner, the pixel electrode 425 can be electrically connected to the pixel electrode 435. Accordingly, the pixel electrode 425 and the pixel electrode 435 can be driven not individually but by the transistor 420, which leads to a reduction in power consumption of a liquid crystal display device. In addition, the manufacturing steps of the liquid crystal display device can be decreased to reduce the manufacturing costs.

Similarly, the part of the common electrode 426 covering the convex structural body 428 is in contact with part of a common electrode 436 provided over the first substrate 441. In this manner, the common electrode 426 can be electrically connected to the common electrode 436. Accordingly, the resistance of the common electrode 426 and the common electrode 436 can be reduced, which leads to a reduction in driving voltage of the common electrode 426 and the common electrode 436, so that the power consumption of a liquid crystal display device can be reduced.

Further, although in each of the pixel electrodes and the common electrodes, the wiring region and the comb-like shape are formed of the same conductive film in this embodiment, any of the pixel electrodes and the common electrodes may be formed of different conductive films for the wiring region and the comb-like shape region as shown in FIGS. 38A and 38B in Embodiment 1.

According to this embodiment, in a liquid crystal display device using a liquid crystal layer exhibiting a blue phase, a convex structural body is not formed under the pixel electrode and the common electrode where the lateral electric field is formed, so that a reduction in the contrast ratio can be suppressed and the intensity of the lateral electric field can be enhanced.

### Embodiment 3

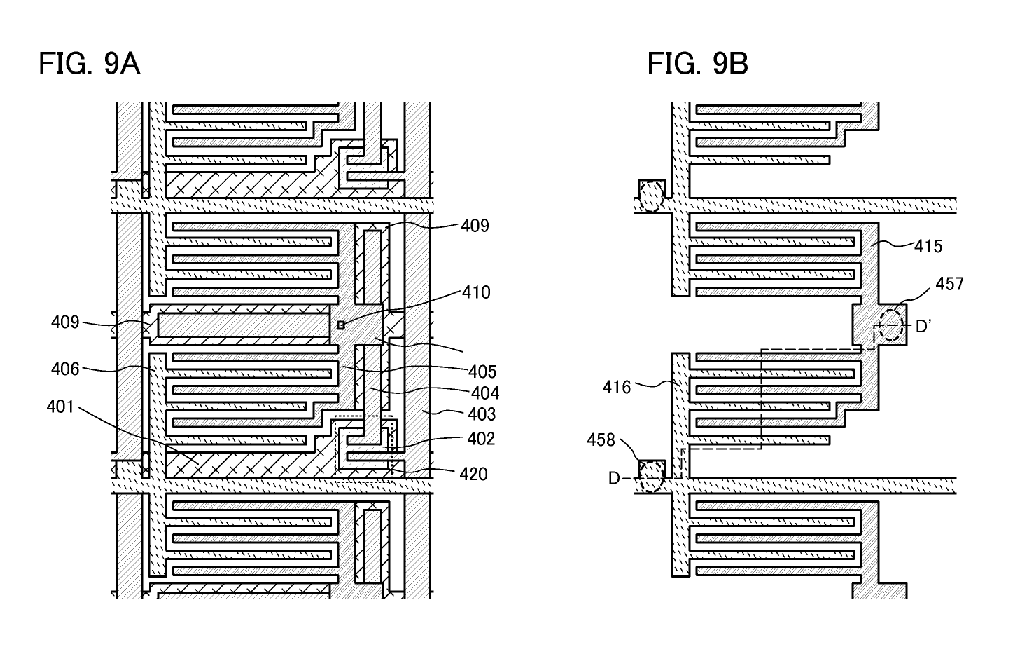

In this embodiment, a liquid crystal display device having a structure different from Embodiment 1 and embodiment 2 is described using FIGS. 9A and 9B, FIG. 10, FIGS. 11A and 11B, and FIG. 12. The same elements as Embodiments 1 and 2 are denoted by the same reference numerals in this embodiment.

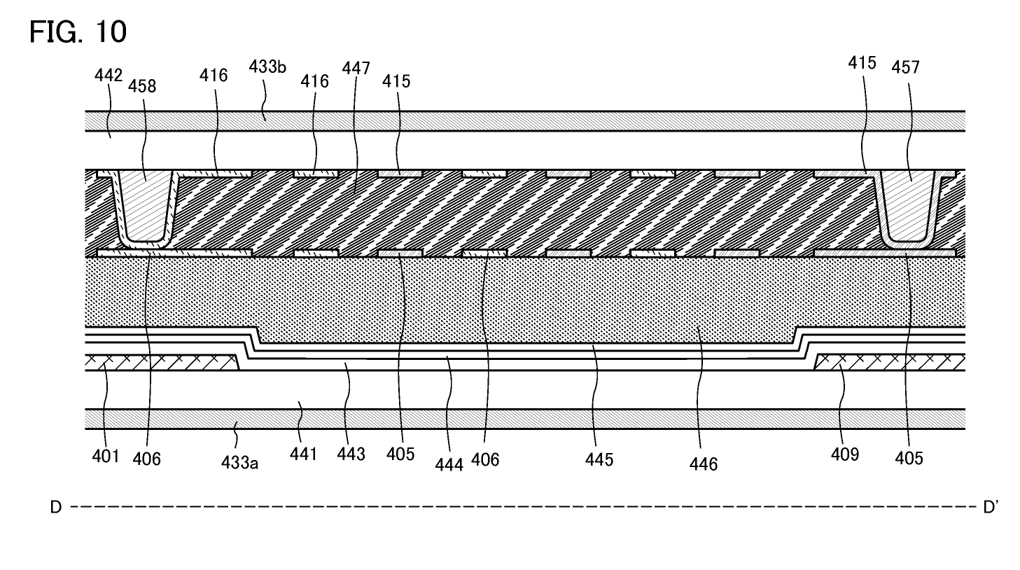

FIG. 9A is a top view on a first substrate side of a liquid crystal display device of this embodiment, and FIG. 9B is a top view on a second substrate side of the liquid crystal display device of this embodiment, each of which illustrates one pixel. FIG. 10 is a cross-sectional view along D-D′ in FIG. 9B.

Although electrodes and wirings are provided over a substrate also in this embodiment like the above embodiment, a top view where the substrate is seen from the side of the electrodes and wirings is shown in FIG. 9A and a top view where the electrodes and wirings are seen from the substrate side is shown in FIG. 9B for clarification of overlap of the electrodes and wirings.

The liquid crystal display device shown in FIGS. 9A and 9B and FIG. 10 has a structure substantially the same as that of Embodiment 1 (see FIGS. 1A and 1B and FIG. 2). However, unlike the liquid crystal display device of Embodiment 1, the convex structural body is provided not for the first substrate 441 that is an element substrate but for the second substrate 442 that is a counter substrate in the liquid crystal display device shown in FIGS. 9A and 9B and FIG. 10.

As shown in FIG. 9B and FIG. 10, a convex structural body 457 and a convex structural body 458 are provided for the second substrate 442.

Part of the pixel electrode 415 covers the convex structural body 457. The part of the pixel electrode 415 covering the convex structural body 457 is in contact with part of the pixel electrode 405 provided over the first substrate 441. In this manner, the pixel electrode 405 can be electrically connected to the pixel electrode 415. Accordingly, the pixel electrode 405 and the pixel electrode 415 can be driven not individually but by the transistor 420, which leads to a reduction in power consumption of a liquid crystal display device. In addition, the manufacturing steps of the liquid crystal display device can be decreased to reduce the manufacturing costs.

Similarly, part of the common electrode 416 covers the convex structural body 458 provided for the second substrate 442. The part of the common electrode 416 covering the convex structural body 458 is in contact with part of the common electrode 406 provided over the first substrate 441. In this manner, the common electrode 406 can be electrically connected to the common electrode 416. Accordingly, the resistance of the common electrode 406 and the common electrode 416 can be reduced, which leads to a reduction in driving voltage of the common electrode 406 and the common electrode 416, so that the power consumption of a liquid crystal display device can be reduced.

The convex structural body 457 and the convex structural body 458 are provided with a space therebetween so as to sandwich the comb-like shape region of the pixel electrode 405, the comb-like shape region of the common electrode 406, the comb-like shape region of the pixel electrode 415, and the comb-like shape region of the common electrode 416 therebetween. That is, the convex structural bodies 457 and 458 are provided so as not to overlap with either the pixel electrode or the common electrode where the lateral electric field is formed. Accordingly, the convex structural bodies 457 and 458 do not prevent liquid crystal molecules from being oriented in the lateral electric field.

The convex structural body 457 and the convex structural body 458 are provided so as to overlap with the capacitor wiring layer 409 and the gate wiring layer 401, respectively. The capacitor wiring layer 409 and the gate wiring layer 401 block light, so that light does not pass through the convex structural bodies 457 and 458 and the peripheral portions thereof. Accordingly, an optical polarization action does not occur, so that the contrast ratio of a liquid crystal display device is not decreased.

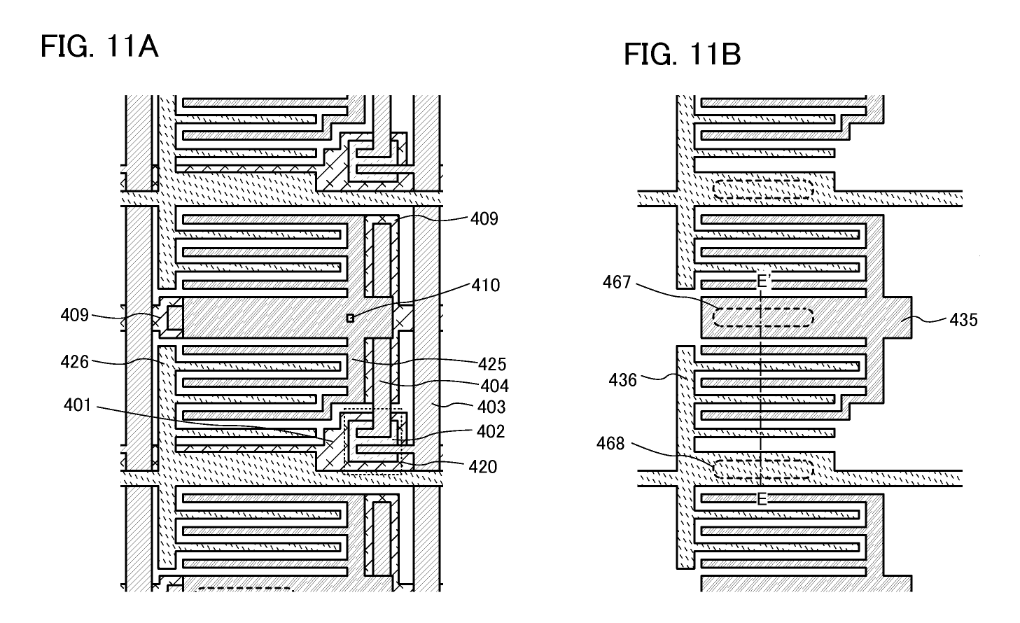

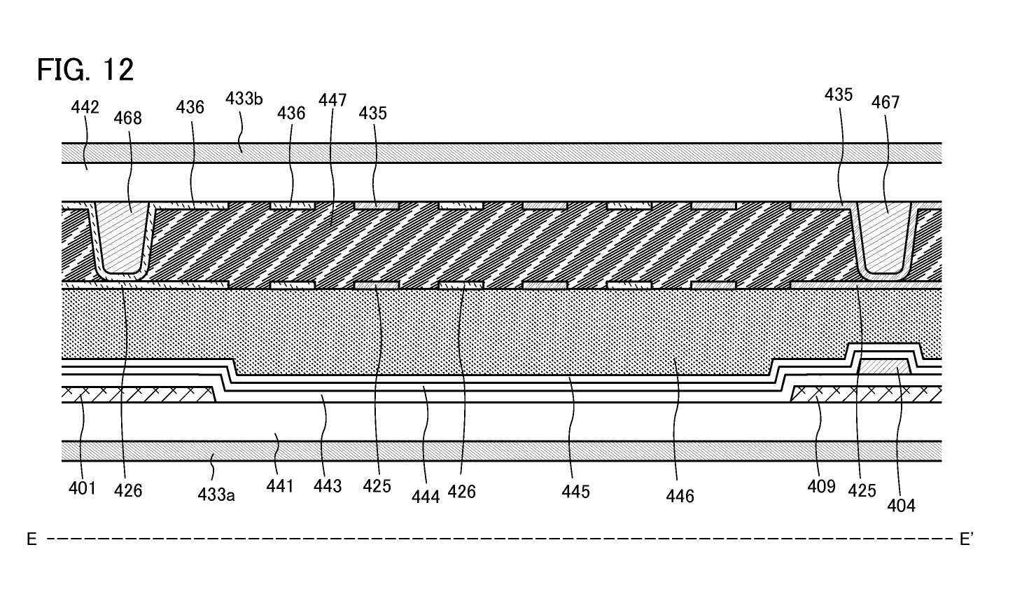

FIG. 11A is a top view on a first substrate side of a liquid crystal display device of this embodiment, and FIG. 11B is a top view on a second substrate side of the liquid crystal display device of this embodiment, each of which illustrates one pixel. FIG. 12 is a cross-sectional view along E-E′ in FIG. 11B.

Although electrodes and wirings are provided over a substrate also in this embodiment like the above embodiment, a top view where the substrate is seen from the side of the electrodes and wirings is shown in FIG. 11A and a top view where the electrodes and wirings are seen from the substrate side is shown in FIG. 11B for clarification of overlap of the electrodes and wirings.

The liquid crystal display device shown in FIGS. 11A and 11B and FIG. 12 has a structure substantially the same as that of Embodiment 2 (see FIGS. 7A and 7B and FIG. 8). However, unlike the liquid crystal display device of Embodiment 2, the convex structural body is provided not for the first substrate 441 that is an element substrate but for the second substrate 442 that is a counter substrate in the liquid crystal display device shown in FIGS. 11A and 11B and FIG. 12.

As shown in FIG. 11B and FIG. 12, a convex structural body 467 and a convex structural body 468 are provided for the second substrate 442.

The convex structural body 467 and the convex structural body 468 of this embodiment extend in the direction in which the comb-like shape region of the pixel electrode 435 and the comb-like shape region of the common electrode 436 extend. Thus, part of the pixel electrode 435 which covers the convex structural body 467 and part of the common electrode 436 which covers the convex structural body 468 also extend in the direction in which the comb-like shape region of the pixel electrode 435 and the comb-like shape region of the common electrode 436 extend.

With the above-described arrangement of the convex structural bodies 467 and 468, the intensity of the lateral electric field can be enhanced by the part of the pixel electrode 435 which covers the convex structural body 467 and the part of the common electrode 436 which covers the convex structural body 468. That is, the part of the pixel electrode 435 and the part of the common electrode 436 exist in the height direction (film thickness direction) of the liquid crystal layer 447, so that the lateral electric field is formed widely also in the height direction (film thickness direction), whereby the lateral electric field can be formed evenly over a wide region between the pixel electrode and the common electrode.

Further, the convex structural body 467 and the convex structural body 468 are provided so as to overlap with the capacitor wiring layer 409 and the gate wiring layer 401, respectively. The capacitor wiring layer 409 and the gate wiring layer 401 block light, so that light does not pass through the convex structural bodies 467 and 468 and the peripheral portions thereof. Accordingly, an optical polarization action does not occur, so that the contrast ratio of a liquid crystal display device is not decreased.

Further, like Embodiment 2, the part of the pixel electrode 435 covering the convex structural body 467 is in contact with part of the pixel electrode 425 provided over the first substrate 441. In this manner, the pixel electrode 425 can be electrically connected to the pixel electrode 435. Accordingly, the pixel electrode 425 and the pixel electrode 435 can be driven not individually but by the transistor 420, which leads to a reduction in power consumption of a liquid crystal display device. In addition, the manufacturing steps of the liquid crystal display device can be decreased to reduce the manufacturing costs.

Similarly, the part of the common electrode 436 covering the convex structural body 468 is in contact with part of the common electrode 426 provided over the first substrate 441. In this manner, the common electrode 426 can be electrically connected to the common electrode 436. Accordingly, the resistance of the common electrode 426 and the common electrode 436 can be reduced, which leads to a reduction in driving voltage of the common electrode 426 and the common electrode 436, so that the power consumption of a liquid crystal display device can be reduced. Further, the manufacturing steps of the liquid crystal display device can be reduced to reduce the manufacturing costs.

Further, although in each of the pixel electrodes and the common electrodes, the wiring region and the comb-like shape are formed of the same conductive film in this embodiment, any of the pixel electrodes and the common electrodes may be formed of different conductive films for the wiring region and the comb-like shape region as shown in FIGS. 38A and 38B in Embodiment 1.

According to this embodiment, the driving voltage can be reduced and a reduction in the contrast ratio can be suppressed in a liquid crystal display device using a liquid crystal material exhibiting a blue phase.

### Embodiment 4

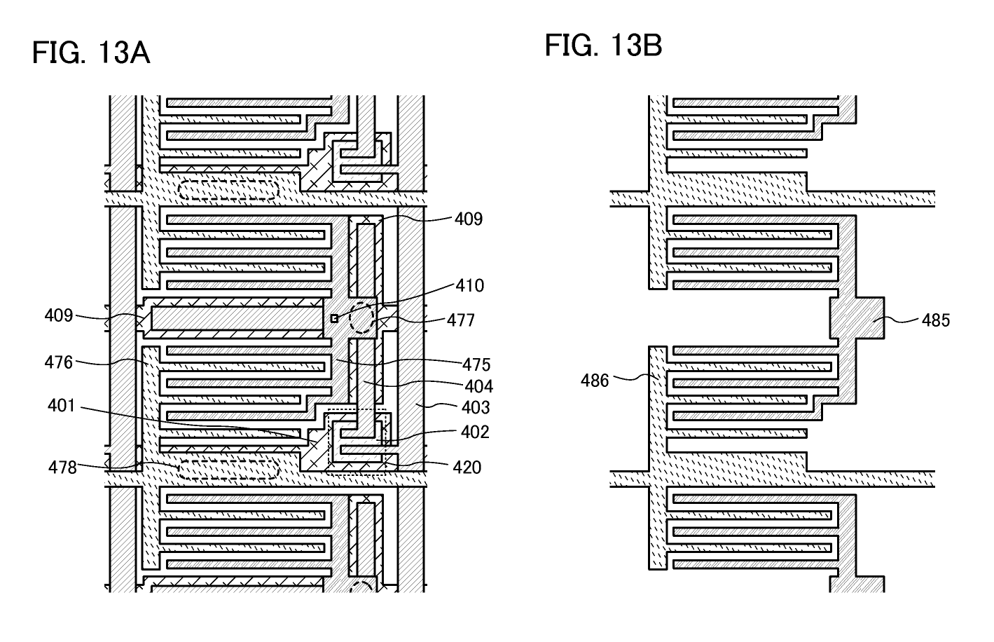

In this embodiment, a liquid crystal display device having a structure different from Embodiments 1 to 3 is described using FIGS. 13A and 13B, FIGS. 14A and 14B, FIGS. 15A and 15B, and FIGS. 16A and 16B. The same elements as Embodiments 1 to 3 are denoted by the same reference numerals in this embodiment.

FIG. 13A is a top view on a first substrate side of a liquid crystal display device of this embodiment, and FIG. 13B is a top view on a second substrate side of the liquid crystal display device of this embodiment, each of which illustrates one pixel.

Although electrodes and wirings are provided over a substrate also in this embodiment like the above embodiment, a top view where the substrate is seen from the side of the electrodes and wirings is shown in FIG. 13A and a top view where the electrodes and wirings are seen from the substrate side is shown in FIG. 13B for clarification of overlap of the electrodes and wirings.

A convex structural body 477 and a convex structural body 478 are provided over the first substrate 441 in the liquid crystal display device shown in FIG. 13A.

The convex structural body 477 and the convex structural body 478 are provided with a space therebetween so as to sandwich the comb-like shape region of a pixel electrode 475, the comb-like shape region of a common electrode 476, the comb-like shape region of a pixel electrode 485, and the comb-like shape region of a common electrode 486 therebetween. That is, the convex structural bodies 477 and 478 are provided so as not to overlap with either the pixel electrode or the common electrode where the lateral electric field is formed. Accordingly, the convex structural bodies 477 and 478 do not prevent liquid crystal molecules from being oriented in the lateral electric field, and the intensity of the lateral electric field is enhanced.

The convex structural body 477 and the convex structural body 478 are provided so as to overlap with the capacitor wiring layer 409 and the gate wiring layer 401, respectively. The capacitor wiring layer 409 and the gate wiring layer 401 block light, so that light does not pass through the convex structural bodies 477 and 478 and the peripheral portions thereof. Accordingly, an optical polarization action does not occur, so that the contrast ratio of a liquid crystal display device is not decreased.

Part of the pixel electrode 475 covering the convex structural body 477 is in contact with part of the pixel electrode 485 provided for the second substrate 442. In this manner, the pixel electrode 475 can be electrically connected to the pixel electrode 485. Accordingly, the pixel electrode 475 and the pixel electrode 485 can be driven not individually but by the transistor 420, which leads to a reduction in power consumption of a liquid crystal display device. In addition, the manufacturing steps of the liquid crystal display device can be decreased to reduce the manufacturing costs.

Similarly, part of the common electrode 476 covering the convex structural body 478 is in contact with part of the common electrode 486 provided for the second substrate 442. In this manner, the common electrode 476 can be electrically connected to the common electrode 486. Accordingly, the resistance of the common electrode 476 and the common electrode 486 can be reduced, which leads to a reduction in driving voltage of the common electrode 476 and the common electrode 486, so that the power consumption of a liquid crystal display device can be reduced.

The convex structural body 478 of this embodiment extends in the direction in which the comb-like shape region of the pixel electrode 475 and the comb-like shape region of the common electrode 476 extend. Thus, the part of the common electrode 476 which covers the convex structural body 478 also extends in the direction in which the comb-like shape region of the common electrode 476 extends.

With the above-described arrangement of the convex structural body 478, the intensity of the lateral electric field can be enhanced by the part of the common electrode 476 which covers the convex structural body 478. That is, the part of the common electrode 476 exists in the height direction (film thickness direction) of the liquid crystal layer 447, so that the lateral electric field is formed widely also in the height direction (film thickness direction), whereby the lateral electric field can be formed evenly over a wide region between the pixel electrode and the common electrode.

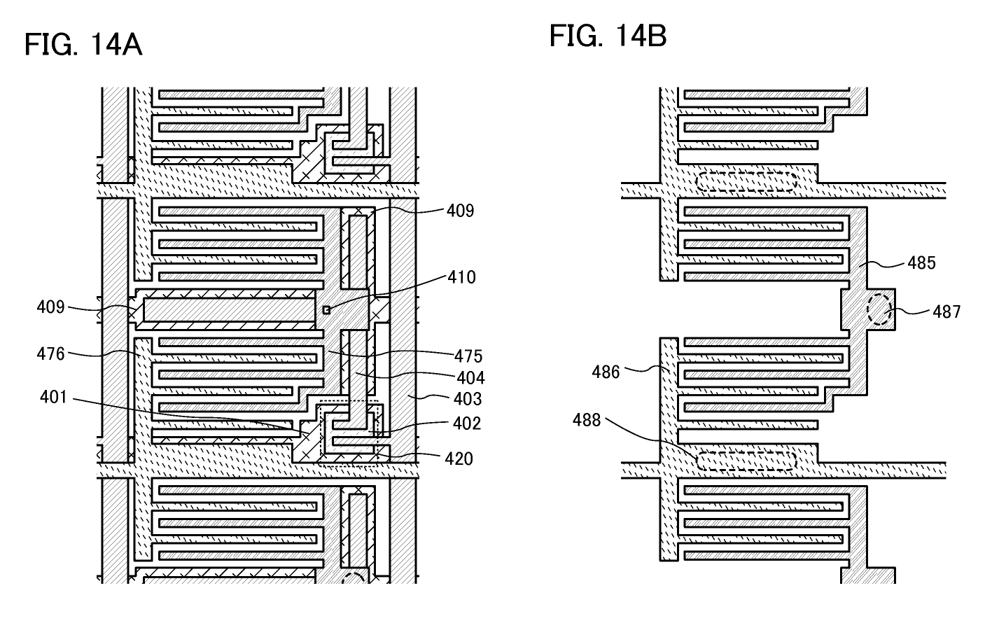

FIG. 14A is a top view on a first substrate side of a liquid crystal display device of this embodiment, and FIG. 14B is a top view on a second substrate side of the liquid crystal display device of this embodiment, each of which illustrates one pixel.

Although electrodes and wirings are provided over a substrate also in this embodiment like the above embodiment, a top view where the substrate is seen from the side of the electrodes and wirings is shown in FIG. 14A and a top view where the electrodes and wirings are seen from the substrate side is shown in FIG. 14B for clarification of overlap of the electrodes and wirings.

A convex structural body 487 and a convex structural body 488 are provided for the second substrate 442 in the liquid crystal display device shown in FIG. 14B.

The convex structural body 487 and the convex structural body 488 are provided with a space therebetween so as to sandwich the comb-like shape region of the pixel electrode 475, the comb-like shape region of the common electrode 476, the comb-like shape region of the pixel electrode 485, and the comb-like shape region of the common electrode 486 therebetween. That is, the convex structural bodies 487 and 488 are provided so as not to overlap with either the pixel electrode or the common electrode where the lateral electric field is formed. Accordingly, the convex structural bodies 487 and 488 do not prevent liquid crystal molecules from being oriented in the lateral electric field, and the intensity of the lateral electric field is enhanced.

The convex structural body 487 and the convex structural body 488 are provided so as to overlap with the capacitor wiring layer 409 and the gate wiring layer 401, respectively. The capacitor wiring layer 409 and the gate wiring layer 401 block light, so that light does not pass through the convex structural bodies 487 and 488 and the peripheral portions thereof. Accordingly, an optical polarization action does not occur, so that the contrast ratio of a liquid crystal display device is not decreased.

Part of the pixel electrode 485 covering the convex structural body 487 is in contact with part of the pixel electrode 475 provided over the first substrate 441. In this manner, the pixel electrode 475 can be electrically connected to the pixel electrode 485. Accordingly, the pixel electrode 475 and the pixel electrode 485 can be driven not individually but by the transistor 420, which leads to a reduction in power consumption of a liquid crystal display device. In addition, the manufacturing steps of the liquid crystal display device can be decreased to reduce the manufacturing costs.

Similarly, part of the common electrode 486 covering the convex structural body 488 is in contact with part of the common electrode 476 provided over the first substrate 441. In this manner, the common electrode 476 can be electrically connected to the common electrode 486. Accordingly, the resistance of the common electrode 476 and the common electrode 486 can be reduced, which leads to a reduction in driving voltage of the common electrode 476 and the common electrode 486, so that the power consumption of a liquid crystal display device can be reduced.

The convex structural body 488 of this embodiment extends in the direction in which the comb-like shape region of the pixel electrode 485 and the comb-like shape region of the common electrode 486 extend. Thus, the part of the common electrode 486 which covers the convex structural body 488 also extends in the direction in which the comb-like shape region of the common electrode 486 extends.

With the above-described arrangement of the convex structural body 488, the intensity of the lateral electric field can be enhanced by the part of the common electrode 486 which covers the convex structural body 488. That is, the part of the common electrode 486 exists in the height direction (film thickness direction) of the liquid crystal layer 447, so that the lateral electric field is formed widely also in the height direction (film thickness direction), whereby the lateral electric field can be formed evenly over a wide region between the pixel electrode and the common electrode.

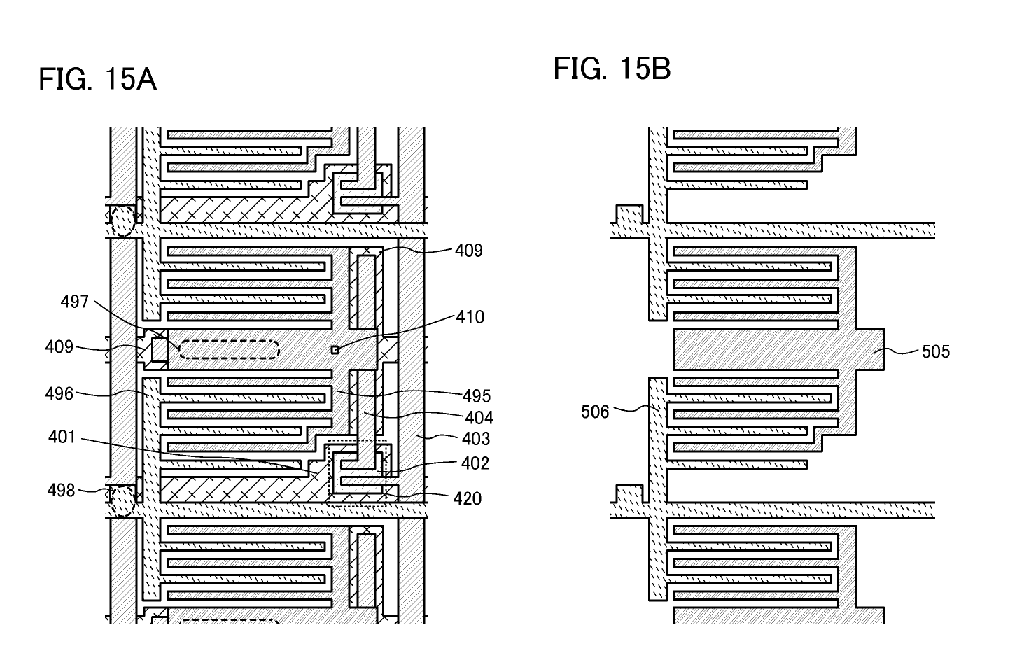

FIG. 15A is a top view on a first substrate side of a liquid crystal display device of this embodiment, and FIG. 15B is a top view on a second substrate side of the liquid crystal display device of this embodiment, each of which illustrates one pixel.

Although electrodes and wirings are provided over a substrate also in this embodiment like the above embodiment, a top view where the substrate is seen from the side of the electrodes and wirings is shown in FIG. 15A and a top view where the electrodes and wirings are seen from the substrate side is shown in FIG. 15B for clarification of overlap of the electrodes and wirings.

A convex structural body 497 and a convex structural body 498 are provided over the first substrate 441 in the liquid crystal display device shown in FIG. 15A.

The convex structural body 497 and the convex structural body 498 are provided so as to overlap with the capacitor wiring layer 409 and the gate wiring layer 401, respectively. The capacitor wiring layer 409 and the gate wiring layer 401 block light, so that light does not pass through the convex structural bodies 497 and 498 and the peripheral portions thereof. Accordingly, an optical polarization action does not occur, so that the contrast ratio of a liquid crystal display device is not decreased.

Part of a pixel electrode 495 covering the convex structural body 497 is in contact with part of a pixel electrode 505 provided for the second substrate 442. In this manner, the pixel electrode 495 can be electrically connected to the pixel electrode 505. Accordingly, the pixel electrode 495 and the pixel electrode 505 can be driven not individually but by the transistor 420, which leads to a reduction in power consumption of a liquid crystal display device. In addition, the manufacturing steps of the liquid crystal display device can be decreased to reduce the manufacturing costs.

Similarly, part of a common electrode 496 covering the convex structural body 498 is in contact with part of a common electrode 506 provided for the second substrate 442. In this manner, the common electrode 496 can be electrically connected to the common electrode 506. Accordingly, the resistance of the common electrode 496 and the common electrode 506 can be reduced, which leads to a reduction in driving voltage of the common electrode 496 and the common electrode 506, so that the power consumption of a liquid crystal display device can be reduced.

The convex structural body 497 of this embodiment extends in the direction in which the comb-like shape region of the pixel electrode 495 and the comb-like shape region of the common electrode 496 extend. Thus, the part of the pixel electrode 495 which covers the convex structural body 497 also extends in the direction in which the comb-like shape region of the pixel electrode 495 extends.

With the above-described arrangement of the convex structural body 497, the intensity of the lateral electric field can be enhanced by the part of the pixel electrode 495 which covers the convex structural body 497. That is, the part of the pixel electrode 495 exists in the height direction (film thickness direction) of the liquid crystal layer 447, so that the lateral electric field is formed widely also in the height direction (film thickness direction), whereby the lateral electric field can be formed evenly over a wide region between the pixel electrode and the common electrode.

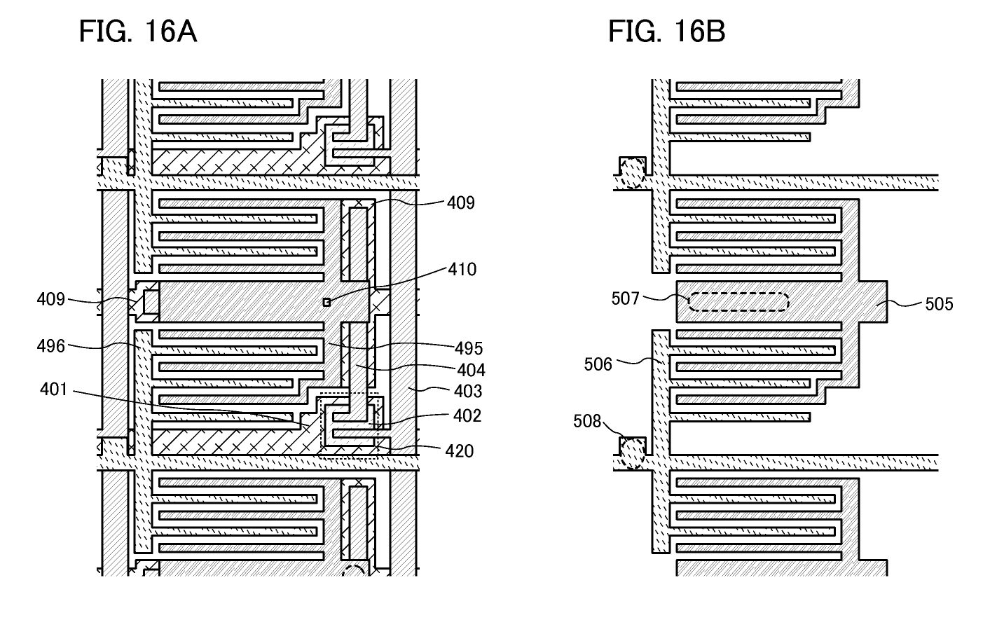

FIG. 16A is a top view on a first substrate side of a liquid crystal display device of this embodiment, and FIG. 16B is a top view on a second substrate side of the liquid crystal display device of this embodiment, each of which illustrates one pixel.

Although electrodes and wirings are provided over a substrate also in this embodiment like the above embodiment, a top view where the substrate is seen from the side of the electrodes and wirings is shown in FIG. 16A and a top view where the electrodes and wirings are seen from the substrate side is shown in FIG. 16B for clarification of overlap of the electrodes and wirings.

A convex structural body 507 and a convex structural body 508 are provided for the second substrate 442 in the liquid crystal display device shown in FIG. 16B.

The convex structural body 507 and the convex structural body 508 are provided so as to overlap with the capacitor wiring layer 409 and the gate wiring layer 401, respectively. The capacitor wiring layer 409 and the gate wiring layer 401 block light, so that light does not pass through the convex structural bodies 507 and 508 and the peripheral portions thereof. Accordingly, an optical polarization action does not occur, so that the contrast ratio of a liquid crystal display device is not decreased.

Part of the pixel electrode 505 covering the convex structural body 507 is in contact with part of the pixel electrode 495 provided over the first substrate 441. In this manner, the pixel electrode 495 can be electrically connected to the pixel electrode 505. Accordingly, the pixel electrode 495 and the pixel electrode 505 can be driven not individually but by the transistor 420, which leads to a reduction in power consumption of a liquid crystal display device. In addition, the manufacturing steps of the liquid crystal display device can be decreased to reduce the manufacturing costs.

Similarly, part of the common electrode 506 covering the convex structural body 508 is in contact with part of the common electrode 496 provided over the first substrate 441. In this manner, the common electrode 496 can be electrically connected to the common electrode 506. Accordingly, the resistance of the common electrode 496 and the common electrode 506 can be reduced, which leads to a reduction in driving voltage of the common electrode 496 and the common electrode 506, so that the power consumption of a liquid crystal display device can be reduced.

The convex structural body 507 of this embodiment extends in the direction in which the comb-like shape region of the pixel electrode 505 and the comb-like shape region of the common electrode 506 extend. Thus, the part of the pixel electrode 505 which covers the convex structural body 507 also extends in the direction in which the comb-like shape region of the pixel electrode 505 extends.

With the above-described arrangement of the convex structural body 507, the intensity of the lateral electric field can be enhanced by the part of the pixel electrode 505 which covers the convex structural body 507. That is, the part of the pixel electrode 505 exists in the height direction (film thickness direction) of the liquid crystal layer 447, so that the lateral electric field is formed widely also in the height direction (film thickness direction), whereby the lateral electric field can be formed evenly over a wide region between the pixel electrode and the common electrode.

Further, although in each of the pixel electrodes and the common electrodes, the wiring region and the comb-like shape are formed of the same conductive film in this embodiment, any of the pixel electrodes and the common electrodes may be formed of different conductive films for the wiring region and the comb-like shape region as shown in FIGS. 38A and 38B in Embodiment 1.

According to this embodiment, the driving voltage can be reduced and a reduction in the contrast ratio can be suppressed in a liquid crystal display device using a liquid crystal material exhibiting a blue phase.

### Embodiment 5

In this embodiment, a liquid crystal display device in which convex structural bodies are provided both for the first substrate 441 that is an element substrate and the second substrate 442 that is a counter substrate is described. The same elements as Embodiments 1 to 4 are denoted by the same reference numerals in this embodiment.

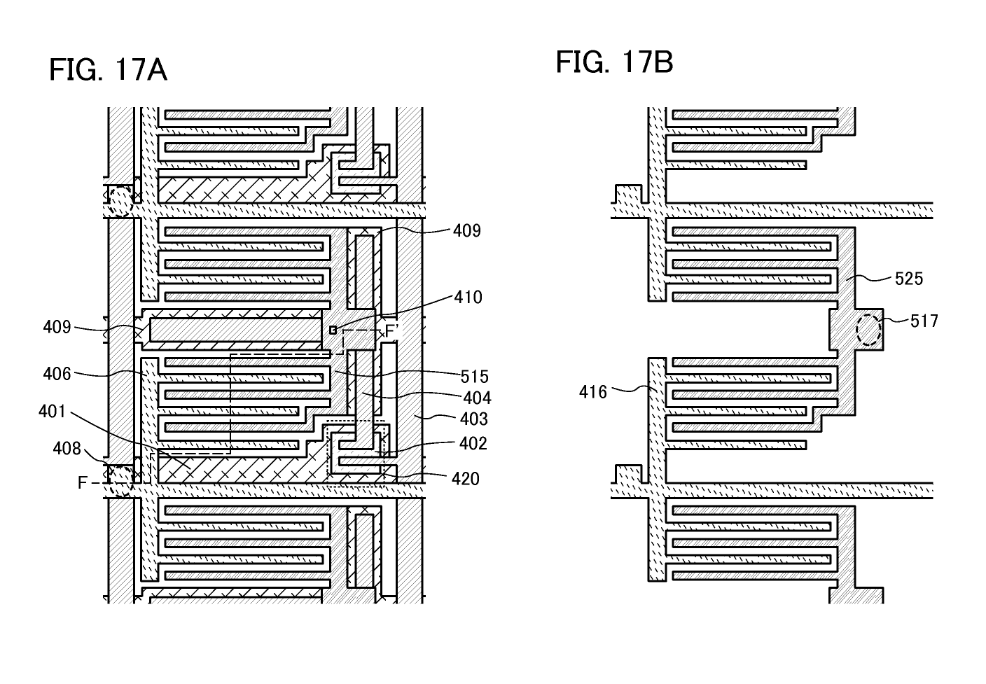

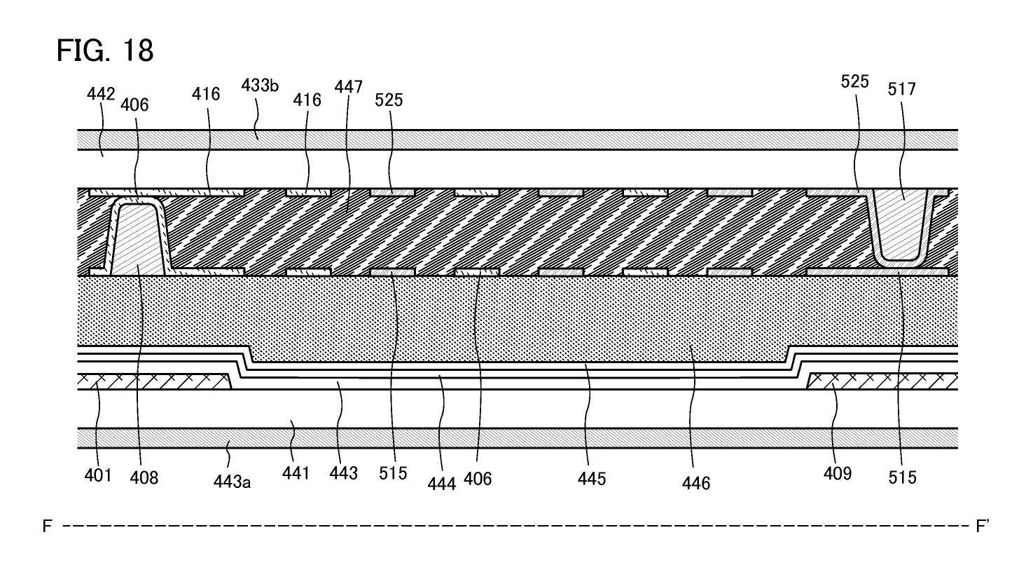

FIG. 17A is a top view on a first substrate side of a liquid crystal display device of this embodiment, and FIG. 17B is a top view on a second substrate side of the liquid crystal display device of this embodiment, each of which illustrates one pixel. FIG. 18 is a cross-sectional view of F-F′ in FIG. 17A.

Although electrodes and wirings are provided over a substrate also in this embodiment like the above embodiment, a top view where the substrate is seen from the side of the electrodes and wirings is shown in FIG. 17A and a top view where the electrodes and wirings are seen from the substrate side is shown in FIG. 17B for clarification of overlap of the electrodes and wirings.

The liquid crystal display device shown in FIGS. 17A and 17B and FIG. 18 is a liquid crystal display device in which the convex structural body 407 in the liquid crystal display device shown in FIGS. 1A and 1B and FIG. 2 is provided for the second substrate 442. In the liquid crystal display device shown in FIGS. 17A and 17B and FIG. 18, a convex structural body 517 is provided for the second substrate 442, and the convex structural body 517 is covered with a pixel electrode 525.

The convex structural body 517 and the convex structural body 408 are provided so as to overlap with the capacitor wiring layer 409 and the gate wiring layer 401, respectively. The capacitor wiring layer 409 and the gate wiring layer 401 block light, so that light does not pass through the convex structural bodies 517 and 408 and the peripheral portions thereof. Accordingly, an optical polarization action does not occur, so that the contrast ratio of a liquid crystal display device is not decreased.

The pixel electrode 525 covering the convex structural body 517 is in contact with a pixel electrode 515 provided over the first substrate 441.

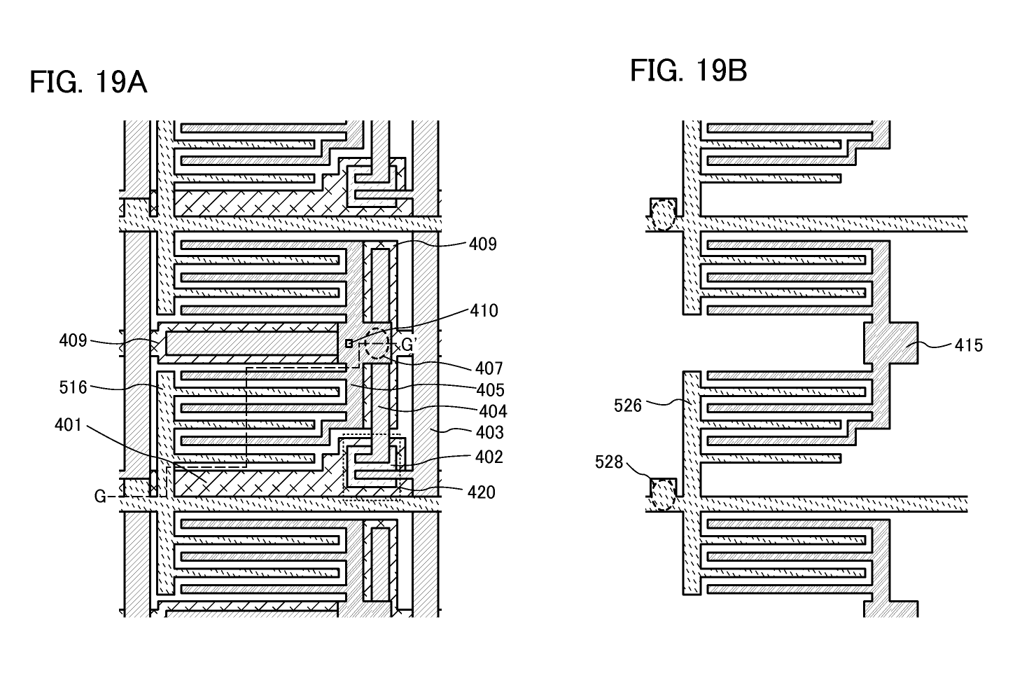

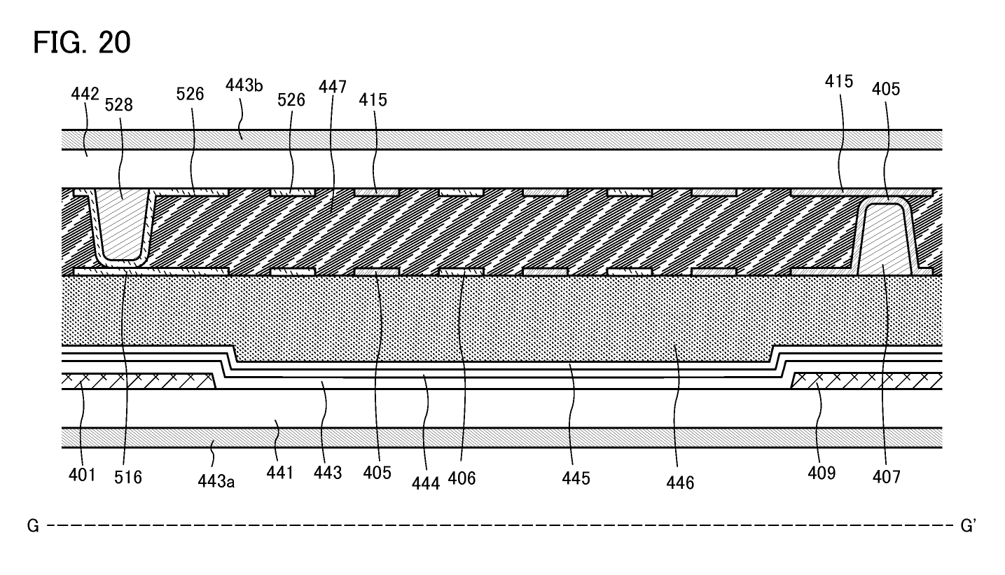

FIG. 19A is a top view on a first substrate side of a liquid crystal display device of this embodiment, and FIG. 19B is a top view on a second substrate side of the liquid crystal display device shown in FIG. 19A, each of which illustrates one pixel. FIG. 20 is a cross-sectional view of G-G′ in FIG. 19A.

Although electrodes and wirings are provided over a substrate also in this embodiment like the above embodiment, a top view where the substrate is seen from the side of the electrodes and wirings is shown in FIG. 19A and a top view where the electrodes and wirings are seen from the substrate side is shown in FIG. 19B for clarification of overlap of the electrodes and wirings.

The liquid crystal display device shown in FIGS. 19A and 19B and FIG. 20 is a liquid crystal display device in which the convex structural body 408 in the liquid crystal display device shown in FIGS. 1A and 1B and FIG. 2 is provided for the second substrate 442. In the liquid crystal display device shown in FIGS. 19A and 19B and FIG. 20, a convex structural body 528 is provided for the second substrate 442, and the convex structural body 528 is covered with a common electrode 526.

The convex structural body 407 and the convex structural body 528 are provided so as to overlap with the capacitor wiring layer 409 and the gate wiring layer 401, respectively. The capacitor wiring layer 409 and the gate wiring layer 401 block light, so that light does not pass through the convex structural bodies 407 and 528 and the peripheral portions thereof. Accordingly, an optical polarization action does not occur, so that the contrast ratio of a liquid crystal display device is not decreased.

The common electrode 526 covering the convex structural body 528 is in contact with a common electrode 516 provided over the first substrate 441.

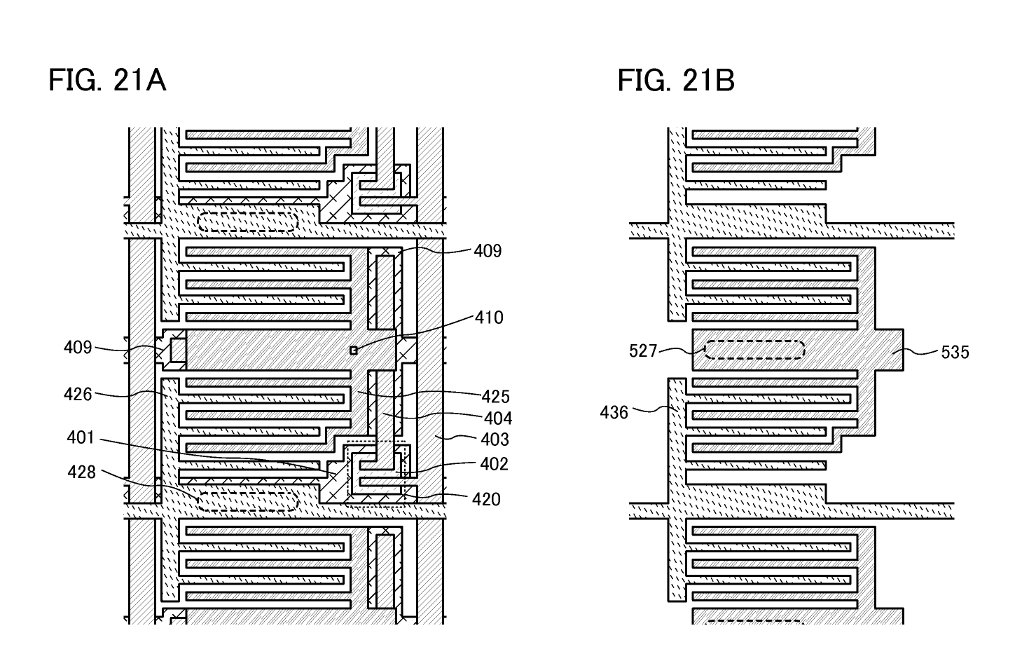

FIG. 21A is a top view on a first substrate side of a liquid crystal display device of this embodiment, and FIG. 21B is a top view on a second substrate side of the liquid crystal display device shown in FIG. 21A, each of which illustrates one pixel.

Although electrodes and wirings are provided over a substrate also in this embodiment like the above embodiment, a top view where the substrate is seen from the side of the electrodes and wirings is shown in FIG. 21A and a top view where the electrodes and wirings are seen from the substrate side is shown in FIG. 21B for clarification of overlap of the electrodes and wirings.

The liquid crystal display device shown in FIGS. 21A and 21B is a liquid crystal display device in which the convex structural body 427 in the liquid crystal display device shown in FIGS. 7A and 7B and FIG. 8 is provided for the second substrate 442. In the liquid crystal display device shown in FIGS. 21A and 21B, a convex structural body 527 is provided for the second substrate 442, and the convex structural body 527 is covered with a pixel electrode 535.

The convex structural body 527 and the convex structural body 428 are provided so as to overlap with the capacitor wiring layer 409 and the gate wiring layer 401, respectively. The capacitor wiring layer 409 and the gate wiring layer 401 block light, so that light does not pass through the convex structural bodies 527 and 428 and the peripheral portions thereof. Accordingly, an optical polarization action does not occur, so that the contrast ratio of a liquid crystal display device is not decreased.

The pixel electrode 535 covering the convex structural body 527 is in contact with the pixel electrode 425 provided over the first substrate 441.

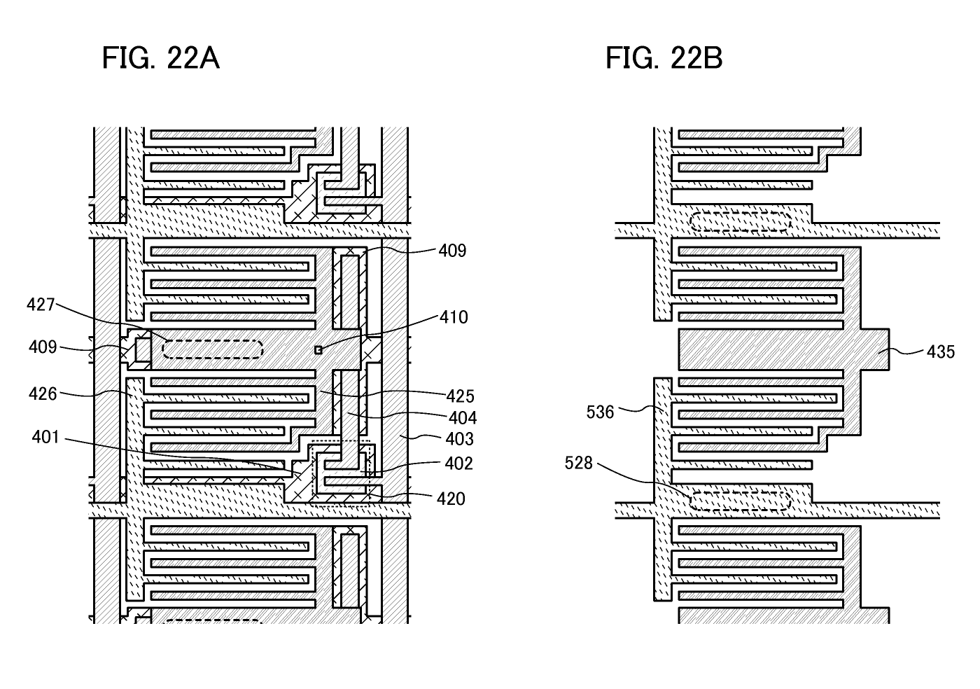

FIG. 22A is a top view on a first substrate side of a liquid crystal display device of this embodiment, and FIG. 22B is a top view on a second substrate side of the liquid crystal display device shown in FIG. 22A, each of which illustrates one pixel.

Although electrodes and wirings are provided over a substrate also in this embodiment like the above embodiment, a top view where the substrate is seen from the side of the electrodes and wirings is shown in FIG. 22A and a top view where the electrodes and wirings are seen from the substrate side is shown in FIG. 22B for clarification of overlap of the electrodes and wirings.

The liquid crystal display device shown in FIGS. 22A and 22B is a liquid crystal display device in which the convex structural body 428 in the liquid crystal display device shown in FIGS. 7A and 7B and FIG. 8 is provided for the second substrate 442. In the liquid crystal display device shown in FIGS. 22A and 22B, a convex structural body 528 is provided for the second substrate 442, and the convex structural body 528 is covered with a common electrode 536.

The convex structural body 427 and the convex structural body 528 are provided so as to overlap with the capacitor wiring layer 409 and the gate wiring layer 401, respectively. The capacitor wiring layer 409 and the gate wiring layer 401 block light, so that light does not pass through the convex structural bodies 427 and 528 and the peripheral portions thereof. Accordingly, an optical polarization action does not occur, so that the contrast ratio of a liquid crystal display device is not decreased.

The common electrode 536 covering the convex structural body 528 is in contact with the common electrode 426 provided over the first substrate 441.

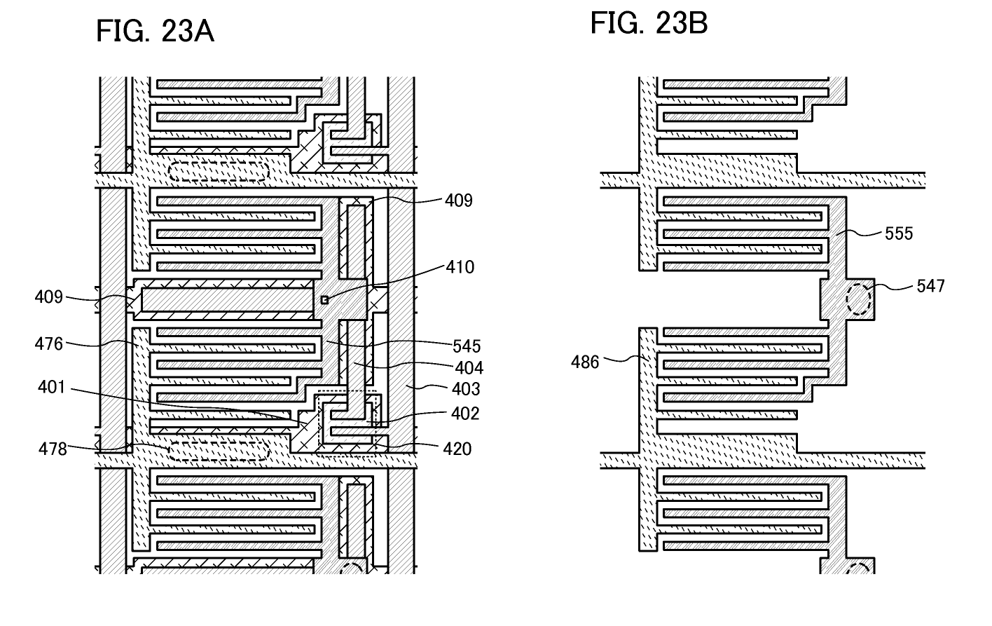

FIG. 23A is a top view on a first substrate side of a liquid crystal display device of this embodiment, and FIG. 23B is a top view on a second substrate side of the liquid crystal display device shown in FIG. 23A, each of which illustrates one pixel.

Although electrodes and wirings are provided over a substrate also in this embodiment like the above embodiment, a top view where the substrate is seen from the side of the electrodes and wirings is shown in FIG. 23A and a top view where the electrodes and wirings are seen from the substrate side is shown in FIG. 23B for clarification of overlap of the electrodes and wirings.

The liquid crystal display device shown in FIGS. 23A and 23B is a liquid crystal display device in which the convex structural body 477 in the liquid crystal display device shown in FIGS. 13A and 13B is provided for the second substrate 442. In the liquid crystal display device shown in FIGS. 23A and 23B, a convex structural body 547 is provided for the second substrate 442, and the convex structural body 547 is covered with a pixel electrode 555.

The convex structural body 547 and the convex structural body 478 are provided so as to overlap with the capacitor wiring layer 409 and the gate wiring layer 401, respectively. The capacitor wiring layer 409 and the gate wiring layer 401 block light, so that light does not pass through the convex structural bodies 547 and 478 and the peripheral portions thereof. Accordingly, an optical polarization action does not occur, so that the contrast ratio of a liquid crystal display device is not decreased.

The pixel electrode 555 covering the convex structural body 547 is in contact with a pixel electrode 545 provided over the first substrate 441.

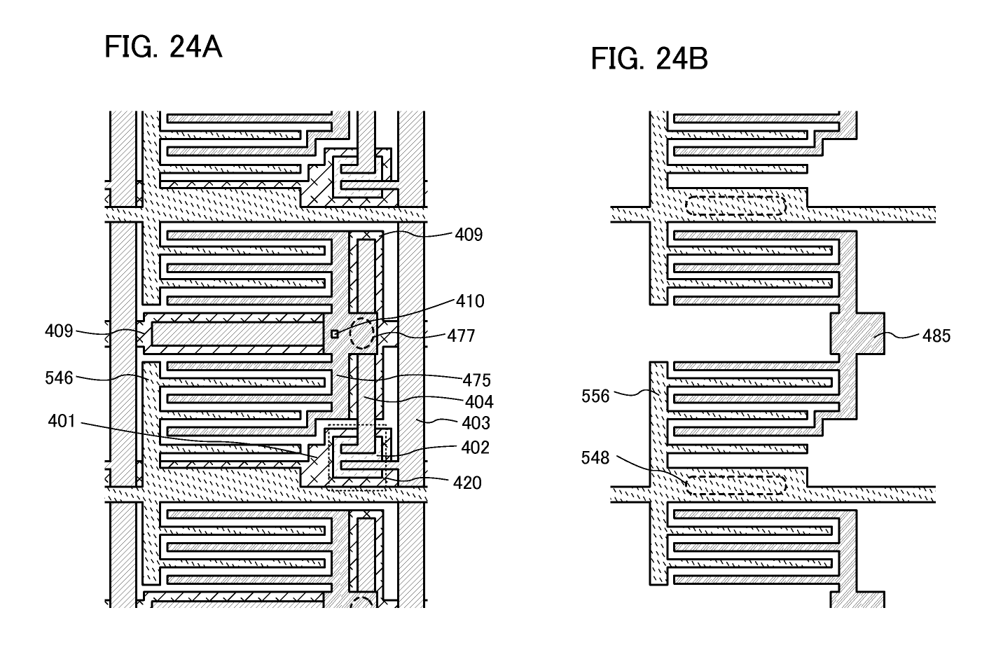

FIG. 24A is a top view on a first substrate side of a liquid crystal display device of this embodiment, and FIG. 24B is a top view on a second substrate side of the liquid crystal display device shown in FIG. 24A, each of which illustrates one pixel.

Although electrodes and wirings are provided over a substrate also in this embodiment like the above embodiment, a top view where the substrate is seen from the side of the electrodes and wirings is shown in FIG. 24A and a top view where the electrodes and wirings are seen from the substrate side is shown in FIG. 24B for clarification of overlap of the electrodes and wirings.

The liquid crystal display device shown in FIGS. 24A and 24B is a liquid crystal display device in which the convex structural body 478 in the liquid crystal display device shown in FIGS. 13A and 13B is provided for the second substrate 442. In the liquid crystal display device shown in FIGS. 24A and 24B, a convex structural body 548 is provided for the second substrate 442, and the convex structural body 548 is covered with a common electrode 556.

The convex structural body 477 and the convex structural body 548 are provided so as to overlap with the capacitor wiring layer 409 and the gate wiring layer 401, respectively. The capacitor wiring layer 409 and the gate wiring layer 401 block light, so that light does not pass through the convex structural bodies 477 and 548 and the peripheral portions thereof. Accordingly, an optical polarization action does not occur, so that the contrast ratio of a liquid crystal display device is not decreased.

The common electrode 556 covering the convex structural body 548 is in contact with a common electrode 546 provided over the first substrate 441.

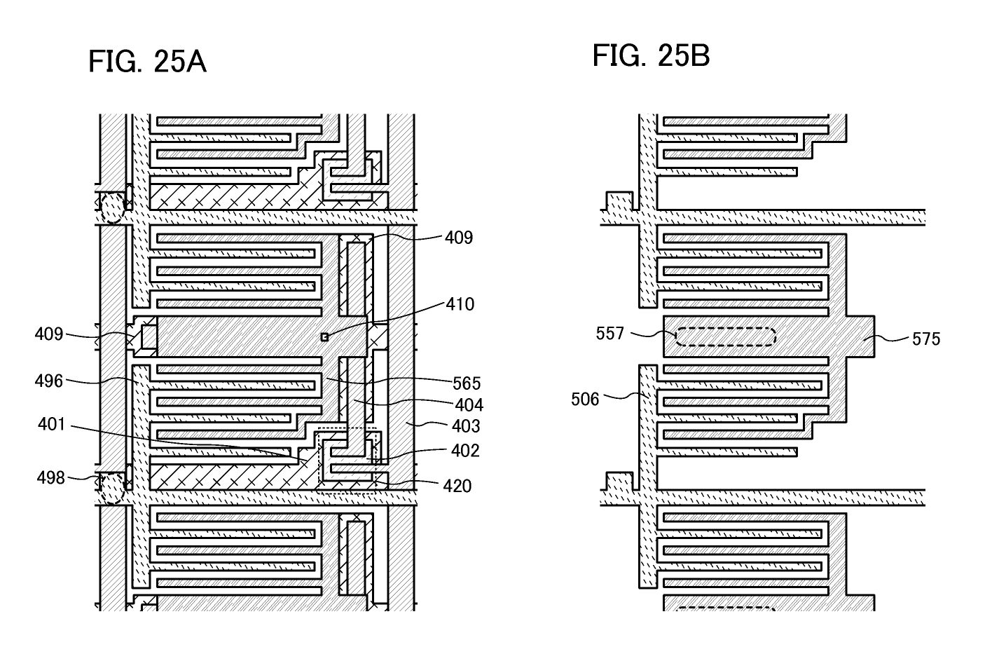

FIG. 25A is a top view on a first substrate side of a liquid crystal display device of this embodiment, and FIG. 25B is a top view on a second substrate side of the liquid crystal display device shown in FIG. 25A, each of which illustrates one pixel.

Although electrodes and wirings are provided over a substrate also in this embodiment like the above embodiment, a top view where the substrate is seen from the side of the electrodes and wirings is shown in FIG. 25A and a top view where the electrodes and wirings are seen from the substrate side is shown in FIG. 25B for clarification of overlap of the electrodes and wirings.

The liquid crystal display device shown in FIGS. 25A and 25B is a liquid crystal display device in which the convex structural body 497 in the liquid crystal display device shown in FIGS. 15A and 15B is provided for the second substrate 442. In the liquid crystal display device shown in FIGS. 25A and 25B, a convex structural body 557 is provided for the second substrate 442, and the convex structural body 557 is covered with a pixel electrode 575.

The convex structural body 557 and the convex structural body 498 are provided so as to overlap with the capacitor wiring layer 409 and the gate wiring layer 401, respectively. The capacitor wiring layer 409 and the gate wiring layer 401 block light, so that light does not pass through the convex structural bodies 557 and 498 and the peripheral portions thereof. Accordingly, an optical polarization action does not occur, so that the contrast ratio of a liquid crystal display device is not decreased.

The pixel electrode 575 covering the convex structural body 557 is in contact with a pixel electrode 565 provided over the first substrate 441.

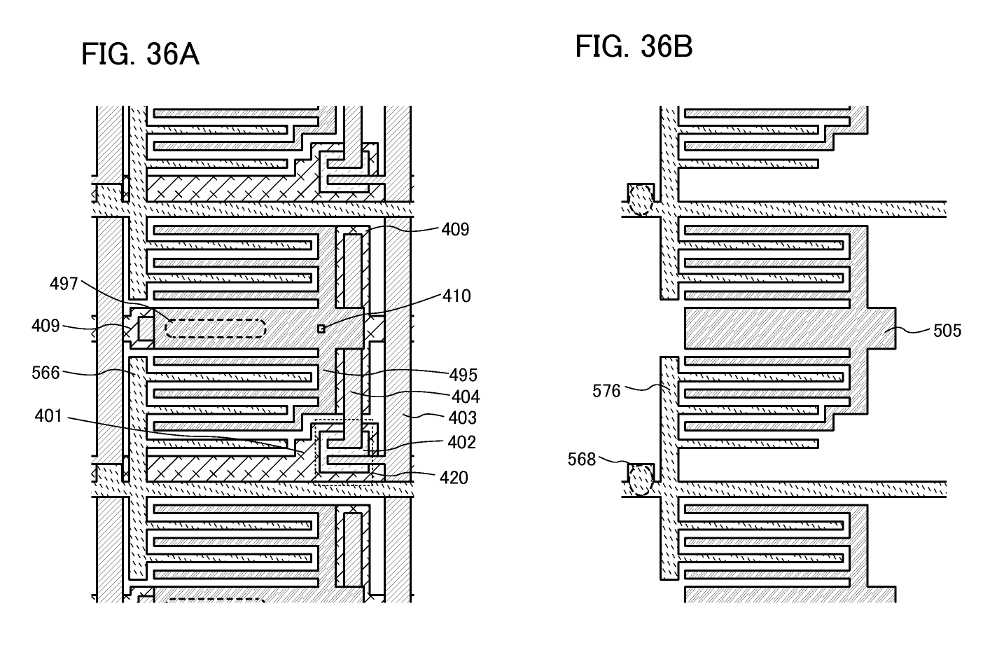

FIG. 36A is a top view on a first substrate side of a liquid crystal display device of this embodiment, and FIG. 36B is a top view on a second substrate side of the liquid crystal display device shown in FIG. 36A, each of which illustrates one pixel.

Although electrodes and wirings are provided over a substrate also in this embodiment like the above embodiment, a top view where the substrate is seen from the side of the electrodes and wirings is shown in FIG. 36A and a top view where the electrodes and wirings are seen from the substrate side is shown in FIG. 36B for clarification of overlap of the electrodes and wirings.

The liquid crystal display device shown in FIGS. 36A and 36B is a liquid crystal display device in which the convex structural body 498 in the liquid crystal display device shown in FIGS. 15A and 15B is provided for the second substrate 442. In the liquid crystal display device shown in FIGS. 36A and 36B, a convex structural body 568 is provided for the second substrate 442, and the convex structural body 568 is covered with a common electrode 576.

The convex structural body 497 and the convex structural body 568 are provided so as to overlap with the capacitor wiring layer 409 and the gate wiring layer 401, respectively. The capacitor wiring layer 409 and the gate wiring layer 401 block light, so that light does not pass through the convex structural bodies 497 and 568 and the peripheral portions thereof. Accordingly, an optical polarization action does not occur, so that the contrast ratio of a liquid crystal display device is not decreased.

The common electrode 576 covering the convex structural body 568 is in contact with a common electrode 566 provided over the first substrate 441.

Further, although in each of the pixel electrodes and the common electrodes, the wiring region and the comb-like shape are formed of the same conductive film in this embodiment, any of the pixel electrodes and the common electrodes may be formed of different conductive films for the wiring region and the comb-like shape region as shown in FIGS. 38A and 38B in Embodiment 1.

According to this embodiment, the driving voltage can be reduced and a reduction in the contrast ratio can be suppressed in a liquid crystal display device using a liquid crystal material exhibiting a blue phase.

### Embodiment 6

In this embodiment, a liquid crystal display device in which a convex structural body provided for the first substrate 441 overlaps with a convex structural body provided for the second substrate 442 is described. The same elements as Embodiments 1 to 5 are denoted by the same reference numerals in this embodiment.

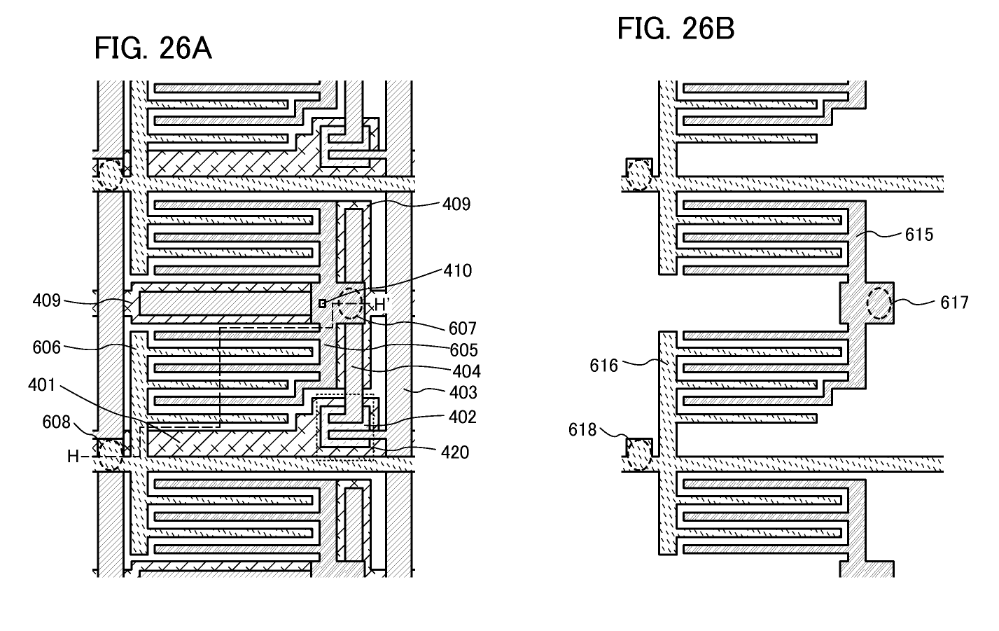

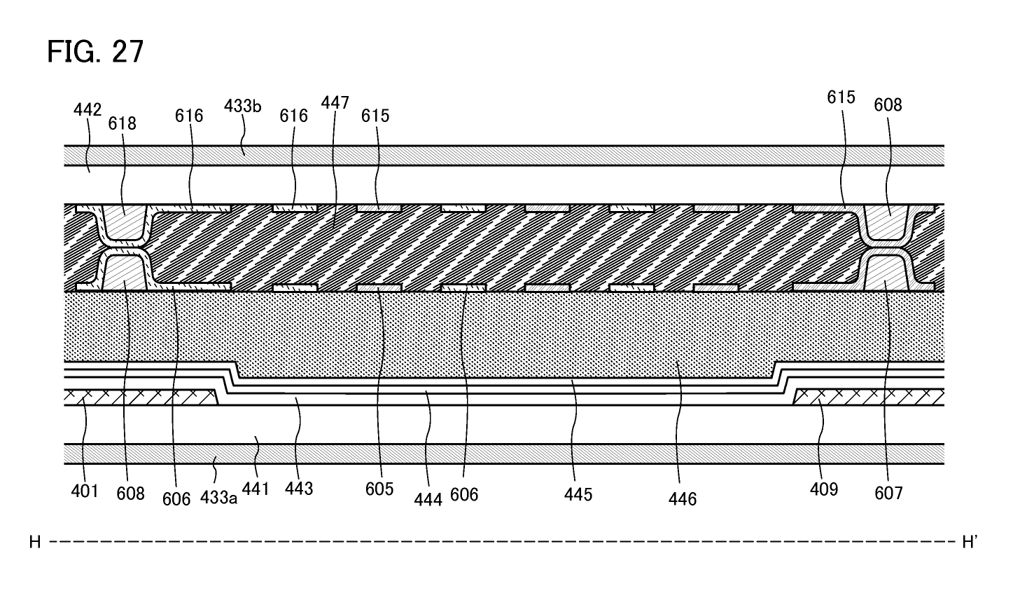

FIG. 26A is a top view on a first substrate side of a liquid crystal display device of this embodiment, and FIG. 26B is a top view on a second substrate side of the liquid crystal display device of this embodiment, each of which illustrates one pixel. FIG. 27 is a cross-sectional view of H—H′ in FIG. 26A.

Although electrodes and wirings are provided over a substrate also in this embodiment like the above embodiment, a top view where the substrate is seen from the side of the electrodes and wirings is shown in FIG. 26A and a top view where the electrodes and wirings are seen from the substrate side is shown in FIG. 26B for clarification of overlap of the electrodes and wirings.

The liquid crystal display device shown in FIGS. 26A and 26B and FIG. 27 is a liquid crystal display device in which convex structural bodies are provided both for the first substrate 441 and the second substrate 442 in the liquid crystal display device shown in FIGS. 1A and 1B and FIG. 2 and the convex structural bodies overlap with each other.

In the liquid crystal display device shown in FIGS. 26A and 26B and FIG. 27, a convex structural body 607 and a convex structural body 608 are provided for the first substrate 441, and a convex structural body 617 and a convex structural body 618 are provided for the second substrate 442.

The convex structural body 607 which is covered with a pixel electrode 605 and the convex structural body 617 which is covered with a pixel electrode 615 are provided so as to overlap with each other. Accordingly, the pixel electrode 605 is in contact with the pixel electrode 615.

Similarly, the convex structural body 608 which is covered with a common electrode 606 and the convex structural body 618 which is covered with a common electrode 616 are provided so as to overlap with each other. Accordingly, the common electrode 606 is in contact with the common electrode 616.

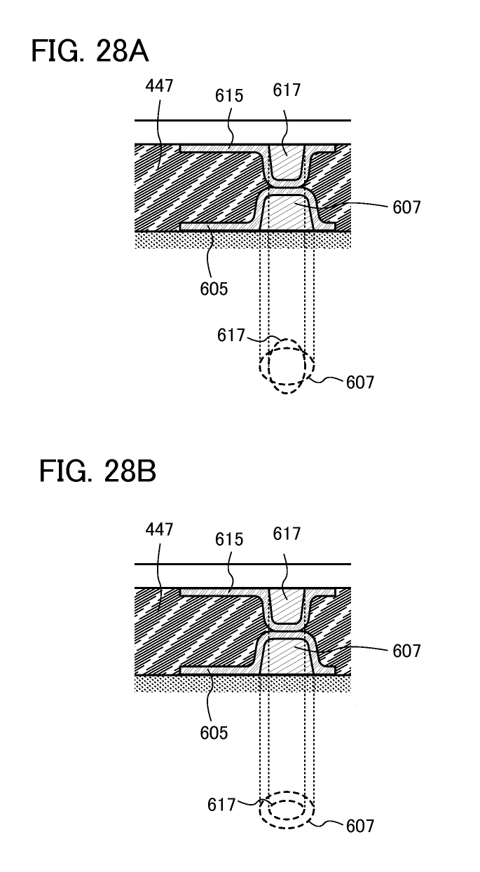

Further, for example, as shown in FIG. 28A, the convex structural body 607 and the convex structural body 617 each may be formed so as to have an elliptical cross section and provided such that their respective long axes are at right angles to each other. Accordingly, even when either the convex structural body 607 or the convex structural body 617 deviates from an appropriate position, a contact defect of the pixel electrode or the common electrode covering the convex structural body can be prevented.

In order to prevent a contact defect of the pixel electrode or the common electrode, the convex structural bodies which overlap with each other may be formed to have different cross-sectional areas. For example, the cross-sectional area of the convex structural body 607 shown in FIG. 28B is larger than that of the convex structural body 617. Accordingly, even when either the convex structural body 607 or the convex structural body 617 deviates from an appropriate position, a contact defect of the pixel electrode or the common electrode covering the convex structural body can be prevented.

Although the cross-sectional shapes of the convex structural body 607 and the convex structural body 617 are elliptical in FIGS. 28A and 28B, one embodiment of the present invention is not limited thereto. For example, the convex structural body may be formed to have a rectangular cross-sectional shape. Further, the above-described shape and arrangement may be applied to not only the convex structural body 607 and the convex structural body 617 but also the other convex structural bodies. Accordingly, a contact defect of the pixel electrode and the common electrode can be prevented.

The convex structural body 607, 608 and the convex structural body 617, 618 are provided so as to overlap with the capacitor wiring layer 409 and the gate wiring layer 401, respectively. The capacitor wiring layer 409 and the gate wiring layer 401 block light, so that light does not pass through the convex structural bodies 607, 608, 617, 618, and the peripheral portions thereof. Accordingly, an optical polarization action does not occur, so that the contrast ratio of a liquid crystal display device is not decreased.

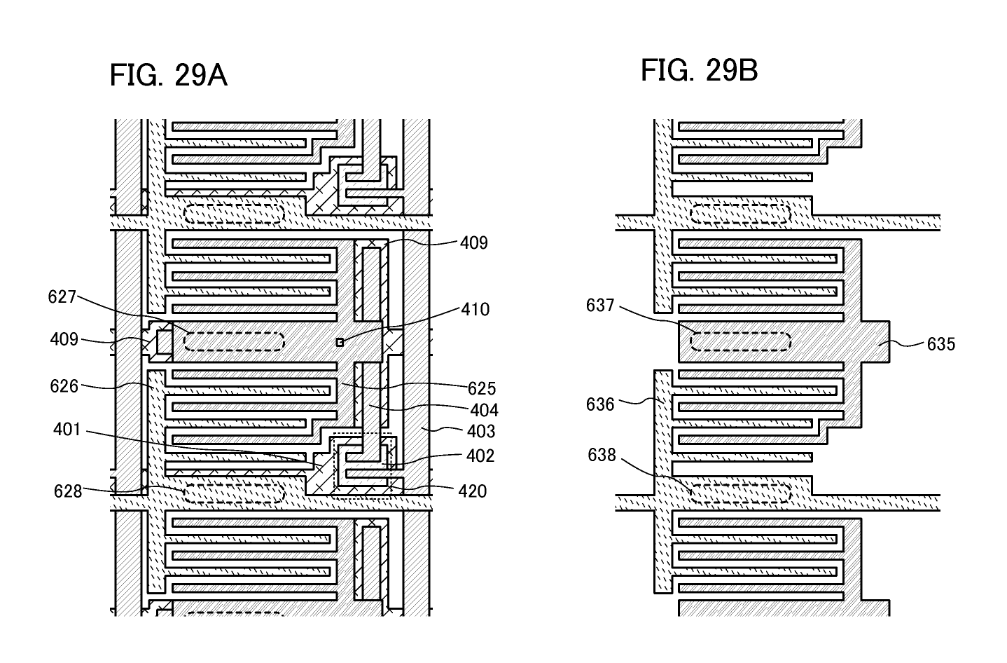

A liquid crystal display device shown in FIGS. 29A and 29B is a liquid crystal display device in which convex structural bodies are provided both for the first substrate 441 and the second substrate 442 in the liquid crystal display device shown in FIGS. 7A and 7B and the convex structural bodies overlap with each other.

Although electrodes and wirings are provided over a substrate also in this embodiment like the above embodiment, a top view where the substrate is seen from the side of the electrodes and wirings is shown in FIG. 29A and a top view where the electrodes and wirings are seen from the substrate side is shown in FIG. 29B for clarification of overlap of the electrodes and wirings.

In the liquid crystal display device shown in FIGS. 29A and 29B, convex structural bodies 627 and 628 are provided over the first substrate 441 and convex structural bodies 637 and 638 are provided for the second substrate 442.

The convex structural body 627 which is covered with a pixel electrode 625 and the convex structural body 637 which is covered with a pixel electrode 635 are provided so as to overlap with each other. Accordingly, the pixel electrode 625 is in contact with the pixel electrode 635.

Similarly, the convex structural body 628 which is covered with a common electrode 626 and the convex structural body 638 which is covered with a common electrode 636 are provided so as to overlap with each other. Accordingly, the common electrode 626 is in contact with the common electrode 636.

The convex structural bodies 627, 628, 637, and 638 shown in FIGS. 29A and 29B extend in the direction in which the comb-like shape region of the pixel electrode 625, the comb-like shape region of the common electrode 626, the comb-like shape region of the pixel electrode 635, and the comb-like shape region of the pixel electrode 636 extend.

Accordingly, part of the pixel electrode 625 covering the convex structural body 627, part of the common electrode 626 covering the convex structural body 628, part of the pixel electrode 635 covering the convex structural body 637, and part of the common electrode 636 covering the convex structural body 638 also extend in the direction in which the comb-like shape regions of the pixel electrodes and the common electrodes extend.

The intensity of the lateral electric field can be enhanced by the part of the pixel electrode 625 covering the convex structural body 627, the part of the common electrode 626 covering the convex structural body 628, the part of the pixel electrode 635 covering the convex structural body 637, and the part of the common electrode 636 covering the convex structural body 638.

The convex structural body 627, 628 and the convex structural body 637, 638 are provided so as to overlap with the capacitor wiring layer 409 and the gate wiring layer 401, respectively. The capacitor wiring layer 409 and the gate wiring layer 401 block light, so that light does not pass through the convex structural bodies 627, 628, 637, 638, and the peripheral portions thereof. Accordingly, an optical polarization action does not occur, so that the contrast ratio of a liquid crystal display device is not decreased.

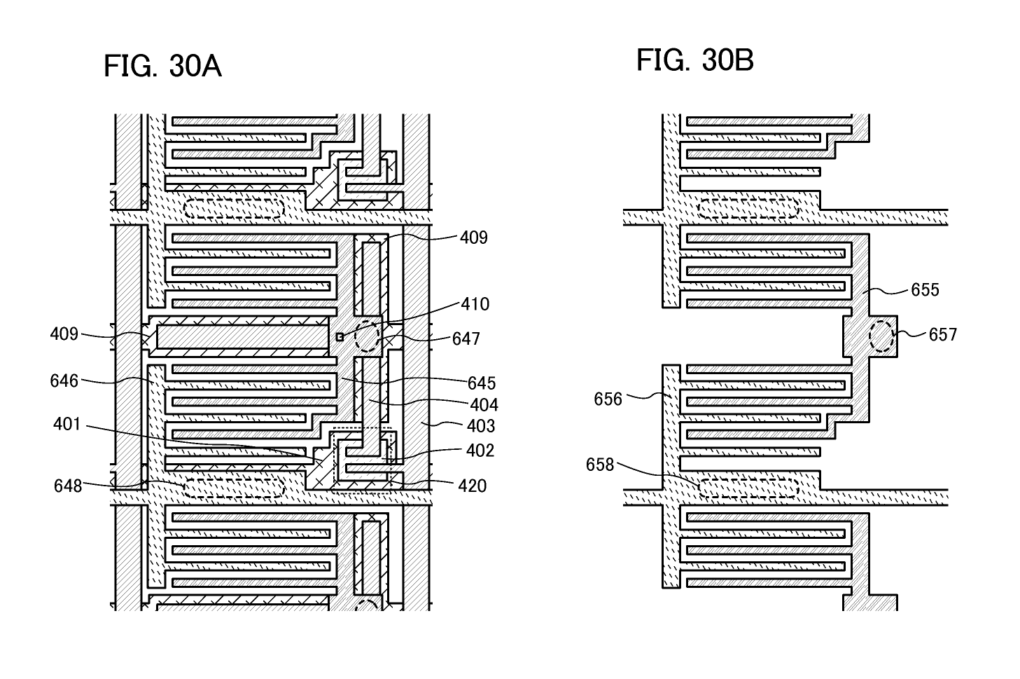

A liquid crystal display device shown in FIGS. 30A and 30B is a liquid crystal display device in which convex structural bodies are provided both for the first substrate 441 and the second substrate 442 in the liquid crystal display device shown in FIGS. 13A and 13B and the convex structural bodies overlap with each other.

Although electrodes and wirings are provided over a substrate also in this embodiment like the above embodiment, a top view where the substrate is seen from the side of the electrodes and wirings is shown in FIG. 30A and a top view where the electrodes and wirings are seen from the substrate side is shown in FIG. 30B for clarification of overlap of the electrodes and wirings.

In the liquid crystal display device shown in FIGS. 30A and 30B, convex structural bodies 647 and 648 are provided over the first substrate 441 and convex structural bodies 657 and 658 are provided for the second substrate 442.

The convex structural body 647 which is covered with a pixel electrode 645 and the convex structural body 657 which is covered with a pixel electrode 655 are provided so as to overlap with each other. Accordingly, the pixel electrode 645 is in contact with the pixel electrode 655.

Similarly, the convex structural body 648 which is covered with a common electrode 646 and the convex structural body 658 which is covered with a common electrode 656 are provided so as to overlap with each other. Accordingly, the common electrode 646 is in contact with the common electrode 656.

The convex structural bodies 648 and 658 shown in FIGS. 30A and 30B extend in the direction in which the comb-like shape region of the pixel electrode 645, the comb-like shape region of the common electrode 646, the comb-like shape region of the pixel electrode 655, and the comb-like shape region of the pixel electrode 656 extend.

Accordingly, part of the common electrode 646 covering the convex structural body 648, and part of the common electrode 656 covering the convex structural body 658 also extend in the direction in which the comb-like shape regions of the pixel electrodes and the common electrodes extend.

The intensity of the lateral electric field can be enhanced by the part of the common electrode 646 covering the convex structural body 648, and the part of the common electrode 656 covering the convex structural body 658.

The convex structural body 647, 648 and the convex structural body 657, 658 are provided so as to overlap with the capacitor wiring layer 409 and the gate wiring layer 401, respectively. The capacitor wiring layer 409 and the gate wiring layer 401 block light, so that light does not pass through the convex structural bodies 647, 648, 657, 658, and the peripheral portions thereof. Accordingly, an optical polarization action does not occur, so that the contrast ratio of a liquid crystal display device is not decreased.

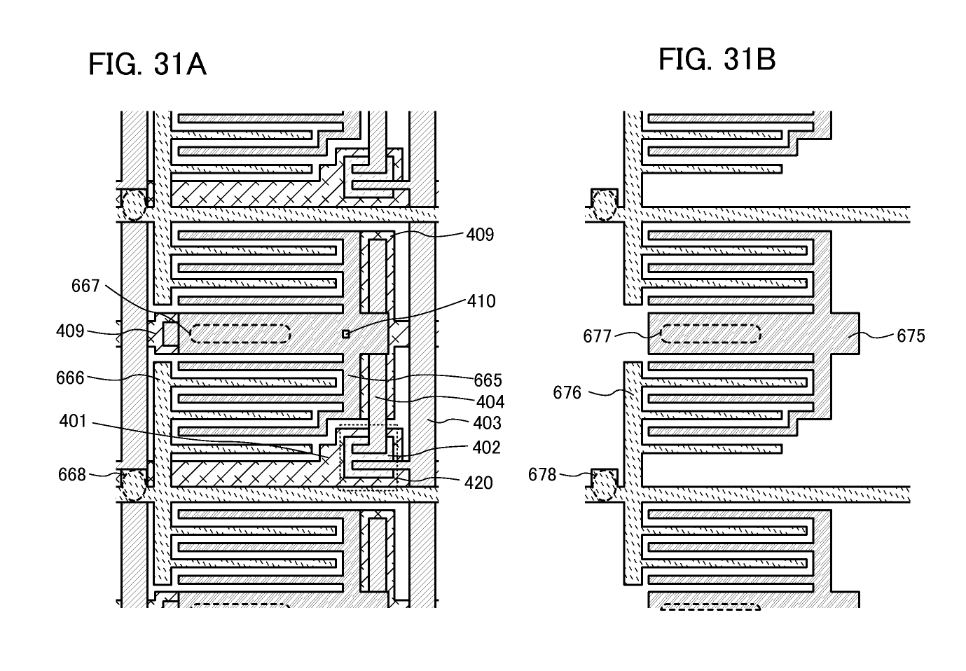

A liquid crystal display device shown in FIGS. 31A and 31B is a liquid crystal display device in which convex structural bodies are provided both for the first substrate 441 and the second substrate 442 in the liquid crystal display device shown in FIGS. 15A and 15B and the convex structural bodies overlap with each other.

Although electrodes and wirings are provided over a substrate also in this embodiment like the above embodiment, a top view where the substrate is seen from the side of the electrodes and wirings is shown in FIG. 31A and a top view where the electrodes and wirings are seen from the substrate side is shown in FIG. 31B for clarification of overlap of the electrodes and wirings.

In the liquid crystal display device shown in FIGS. 31A and 31B, convex structural bodies 667 and 668 are provided over the first substrate 441 and convex structural bodies 677 and 678 are provided for the second substrate 442.

The convex structural body 667 which is covered with a pixel electrode 665 and the convex structural body 677 which is covered with a pixel electrode 675 are provided so as to overlap with each other. Accordingly, the pixel electrode 665 is in contact with the pixel electrode 675.

Similarly, the convex structural body 668 which is covered with a common electrode 666 and the convex structural body 678 which is covered with a common electrode 676 are provided so as to overlap with each other. Accordingly, the common electrode 666 is in contact with the common electrode 676.

The convex structural bodies 668 and 678 shown in FIGS. 31A and 31B extend in the direction in which the comb-like shape region of the pixel electrode 665, the comb-like shape region of the common electrode 666, the comb-like shape region of the pixel electrode 675, and the comb-like shape region of the pixel electrode 676 extend.

Accordingly, part of the pixel electrode 665 covering the convex structural body 667, and part of the pixel electrode 675 covering the convex structural body 677 also extend in the direction in which the comb-like shape regions of the pixel electrodes and the common electrodes extend.

The intensity of the lateral electric field can be enhanced by the part of the pixel electrode 665 covering the convex structural body 667, and the part of the pixel electrode 675 covering the convex structural body 677.

The convex structural body 667, 668 and the convex structural body 677, 678 are provided so as to overlap with the capacitor wiring layer 409 and the gate wiring layer 401, respectively. The capacitor wiring layer 409 and the gate wiring layer 401 block light, so that light does not pass through the convex structural bodies 667, 668, 677, 678, and the peripheral portions thereof. Accordingly, an optical polarization action does not occur, so that the contrast ratio of a liquid crystal display device is not decreased.

Further, although in each of the pixel electrodes and the common electrodes, the wiring region and the comb-like shape are formed of the same conductive film in this embodiment, any of the pixel electrodes and the common electrodes may be formed of different conductive films for the wiring region and the comb-like shape region as shown in FIGS. 38A and 38B in Embodiment 1.

According to this embodiment, the driving voltage can be reduced and a reduction in the contrast ratio can be suppressed in a liquid crystal display device using a liquid crystal material exhibiting a blue phase.

### Embodiment 7

In this embodiment, a liquid crystal panel using the liquid crystal display device described in any of Embodiments 1 to 6 is described.

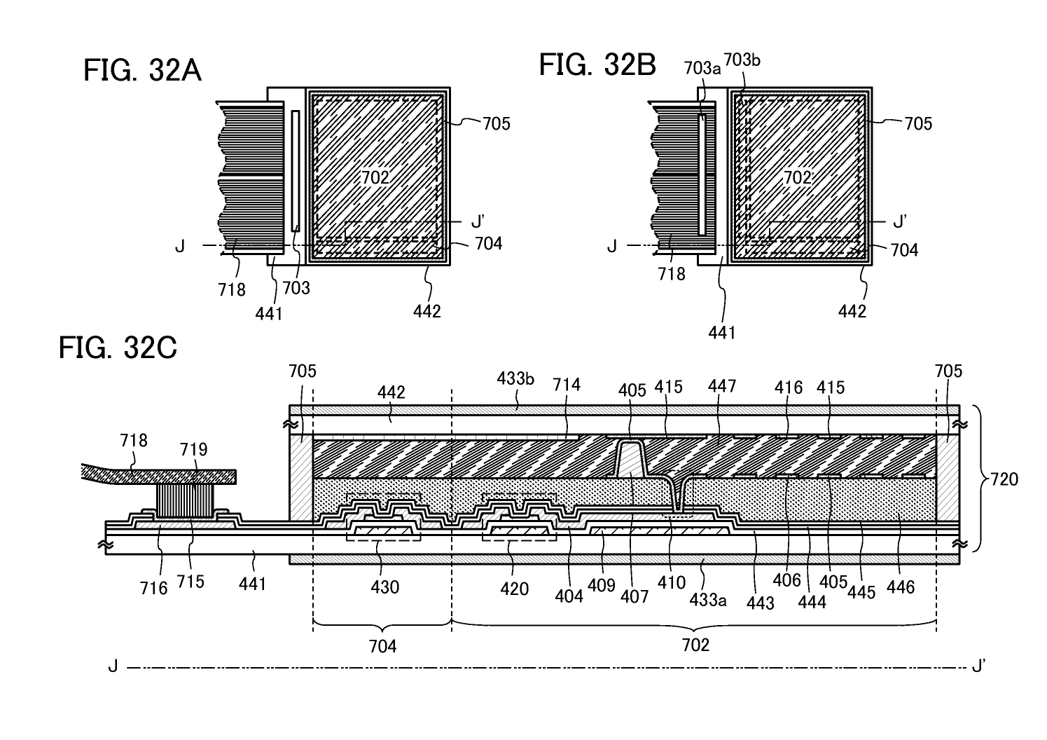

FIGS. 32A and 32B are top views of liquid crystal panels of this embodiment, and FIG. 32C is a cross-sectional view along J-J′ in any of FIGS. 32A and 32B.

As shown in FIGS. 32A and 32B, a sealant 705 is provided to surround a pixel portion 702 and a scan line driver circuit 704 which are provided over the first substrate 441. The second substrate 442 is provided over the pixel portion 702 and the scan line driver circuit 704. Accordingly, the pixel portion 702 and the scan line driver circuit 704 are sealed together with the liquid crystal layer 447 by the first substrate 441, the sealant 705, and the second substrate 442.

Further, in FIG. 32A, a signal line driver circuit 703 which is formed using a single crystal semiconductor film or a polycrystalline semiconductor film over a substrate is mounted in a region which is different from the region surrounded by the sealant 705 over the first substrate 441. FIG. 32B illustrates an example in which part of a signal line driver circuit is formed using a transistor which is provided over the first substrate 441; a signal line driver circuit 703b is formed over the first substrate 441, and a signal line driver circuit 703a which is formed using a single crystal semiconductor film or a polycrystalline semiconductor film is mounted on a substrate separately prepared.

The connection method of a driver circuit which is separately formed is not particularly limited; a COG method, a wire bonding method, a TAB method, or the like can be used. FIG. 32A illustrates an example in which the signal line driver circuit 703 is mounted by a COG method, and FIG. 32B illustrates an example in which the signal line driver circuit 703a is mounted by a TAB method.

The pixel portion 702 provided over the first substrate 441 and the scan line driver circuit 704 include a plurality of transistors. FIG. 32C illustrates the transistor 420 included in the pixel portion 702 and a transistor 430 included in the scan line driver circuit 704. Over the transistors 420 and 430, the insulating films 444 and 445 and the insulating layer 446 are provided.

A transistor having the similar structure as the transistor 420 may be used as the transistor 430. Further, the transistor 430 may be formed in the same process as the transistor 420.

Further, a conductive layer may be provided over the insulating film 445 or the insulating layer 446 so as to overlap with a channel formation region of a semiconductor layer of the transistor 430 in the driver circuit. The conductive layer may have the same potential as or a potential different from that of a gate electrode layer of the transistor 430 and can function as a second gate electrode layer. The potential of the conductive layer may be GND, 0V, or in a floating state.

In the liquid crystal panel of this embodiment, the convex structural body (for example, the convex structural body 407 in FIG. 32) provided in the pixel portion 702 also functions as a spacer that controls the thickness of the liquid crystal layer 447 (cell gap). Thus, a spacer that controls the thickness of the liquid crystal layer 447 is not necessarily provided in addition to the convex structural body. However, a spacer having a columnar shape or the like may be provided if necessary to further control the thickness of the liquid crystal layer 447.

Although FIGS. 32A to 32C illustrate examples of a transmissive liquid crystal display device, an embodiment of the present invention can also be applied to a transflective liquid crystal display device.

Further, although FIGS. 32A to 32C illustrate examples of a liquid crystal display device in which the polarizing plates 433a and 433b are provided on the outer side (on the viewer side) of the substrate, the polarizing plate may be provided on the inner side of the substrate, which may be determined as appropriate depending on a material of the polarizing plate and conditions of the manufacturing process. Further, a light-blocking layer serving as a black matrix may be provided.

In FIGS. 32A to 32C, a light-blocking layer 714 is provided on the second substrate 442 side so as to cover the transistors 420 and 430. With the light-blocking layer 714, the contrast can be improved and the transistors can be stabilized more.

A variety of signals and potentials, which are supplied to the signal line driver circuit 703, the scan line driver circuit 704, and the pixel portion 702, are supplied from an FPC 718.

Further, since the transistor is easily broken by static electricity and the like, a protection circuit for protecting a driver circuit is preferably provided over the same substrate for a gate line or a source line. The protection circuit is preferably formed using a nonlinear element.

In FIGS. 32A to 32C, a connection terminal electrode 715 is formed of the same conductive film as the pixel electrode 405, and a terminal electrode 716 is formed of the same conductive film as the source and drain electrode layers (the wiring layers 403 and 404) of the transistors 420 and 430.

The connection terminal electrode 715 is electrically connected to a terminal of the FPC 718 via an anisotropic conductive film 719.

Although FIGS. 32A to 32C illustrate examples in which the signal line driver circuit 703 is formed separately and mounted on the first substrate 441, an embodiment of the present invention is not limited to this structure. The scan line driver circuit may be separately formed and then mounted, or only part of the signal line driver circuit or part of the scan line driver circuit may be separately formed and then mounted.

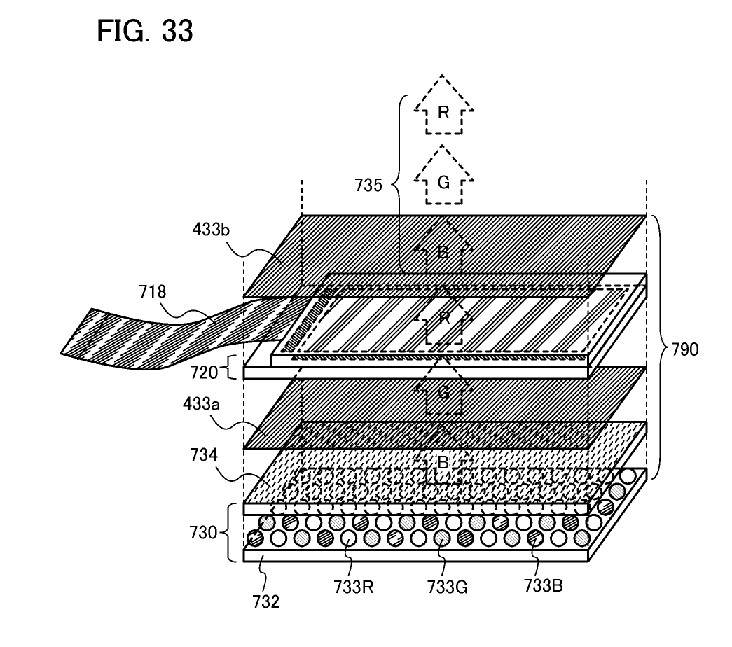

FIG. 33 illustrates a liquid crystal display module using a liquid crystal display panel 720 shown in FIGS. 32A to 32C. A liquid crystal display module 790 shown in FIG. 33 is an example of a liquid crystal display module for performing color display.

The liquid crystal display module 790 includes a backlight portion 730, the liquid crystal display panel 720, and the polarizing plates 433a and 433b which sandwich the liquid crystal display panel 720. A backlight portion including light-emitting elements 733, for example, LEDs of three primary colors (LED 733R, LED 733G, and LED 733B) arranged in a matrix manner and a diffusion plate 734 provided between the liquid crystal display panel 720 and the light-emitting elements can be used as the backlight portion 730. In addition, the FPC 718 serving as an external input terminal is electrically connected to a terminal portion provided in the liquid crystal display panel 720.

In this embodiment, a successive additive color mixing method (a field sequential method) in which color display is performed by time division using light-emitting diodes (LEDs) is employed

The backlight portion 730 includes a backlight control circuit and a backlight 732. The light-emitting elements 733 are arranged in the backlight 732.

In this embodiment, the backlight 732 includes the plurality of light-emitting elements 733 of different emission colors. As for a combination of emission colors, for example, light-emitting elements of three colors, red (R), green (G), and blue (B) can be used. A full-color image can be displayed using the three primary colors: R, G, and B.

Further, a light-emitting element of another color which is exhibited by making some of the light-emitting elements selected from the light-emitting elements of R, G, and B emit light at the same time (for example, yellow (Y) exhibited by R and G, cyan (C) exhibited by G and B, magenta (M) exhibited by B and R, or the like) may be provided in addition to the light-emitting elements of R, G, and B.

Further, a light-emitting element which emits light of a color other than the three primary colors may be added in order to further improve the color reproduction characteristics of the liquid crystal display device. A color which can be exhibited with the light-emitting elements of R, G, and B is limited to a color represented inside a triangle in the chromaticity diagram made by respective three points corresponding to the emission colors of the light-emitting elements. Therefore, by adding a light-emitting element of a color existing outside the triangle in the chromaticity diagram, the color reproduction characteristics of the display device can be improved.

For example, a light-emitting element exhibiting the following color can be used in addition to the light-emitting elements of R, G, and B in the backlight 732: deep blue (DB) represented by a point positioned substantially outside the triangle in a direction from the center of the chromaticity diagram toward the point corresponding to the blue-light-emitting element B; or deep red (DR) represented by a point positioned substantially outside the triangle in a direction from the center of the chromaticity diagram toward the point corresponding to the red-light-emitting element R.

In FIG. 33, light 735 with three colors are schematically denoted by arrows (R, G, and B). Pulsed light of different colors sequentially emitted from the backlight portion 730 is modulated by a liquid crystal element of the liquid crystal display panel 720 which operates in synchronization with the backlight portion 730, and reaches a viewer through the liquid crystal display module 790. The viewer perceives the sequentially emitted light as an image.

The liquid crystal display module illustrated in FIG. 33 can display a full-color image without using a color filter. Light use efficiency is high because there is no absorption of light from the backlight by a color filter, whereby power consumption is suppressed even in display of a full-color image.

The liquid crystal display module described in this embodiment may be provided with a color filter. In such a liquid crystal display module using a color filter, white light is emitted from the backlight portion 730 and passed through the color filter, so that a color-image display is performed.

In this embodiment, the liquid crystal display device, the liquid crystal display panel, and the liquid crystal display module are separately phrased for convenience. However, considering both the liquid crystal display panel and the liquid crystal display module are display devices using a liquid crystal, the liquid crystal display panel and the liquid crystal display module are each also called a liquid crystal display device.

This embodiment can be implemented in appropriate combination with the structures described in the other embodiments.

### Embodiment 8

A liquid crystal display device disclosed in this specification can be applied to a variety of electronic appliances (including game machines). Examples of electronic appliances are a television set (also referred to as a television or a television receiver), a monitor of a computer or the like, a camera such as a digital camera or a digital video camera, a digital photo frame, a mobile phone handset (also referred to as a mobile phone or a mobile phone device), a portable game machine, a portable information terminal, an audio reproducing device, a large-sized game machine such as a pachinko machine, and the like. Examples of electronic appliances each including the liquid crystal display device described in the above embodiment are described.

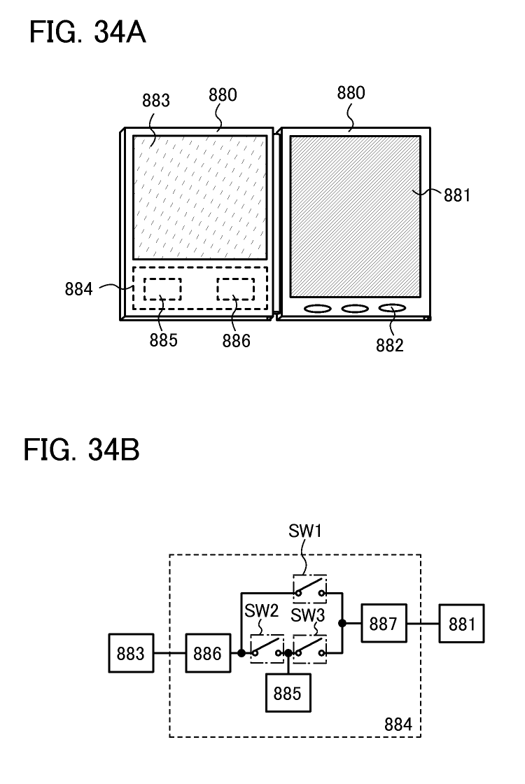

FIG. 34A illustrates an electronic book reader (also referred to as an e-book reader) which can includes a housing 880, a display portion 881, operation keys 882, a solar cell 883, and a charge/discharge control circuit 884. The e-book reader illustrated in FIG. 34A has a function of displaying various kinds of data (e.g., a still image, a moving image, and a text image) on the display portion, a function of displaying a calendar, a date, the time, or the like on the display portion, a function of operating or editing the data displayed on the display portion, a function of controlling processing by various kinds of software (programs), and the like. In FIG. 34A, the charge/discharge control circuit 884 has a battery 885 and a DC-DC converter (hereinafter, abbreviated as a converter) 886. The liquid crystal display device described in any of Embodiments 1 to 7 is applied to the display portion 881, so that the electronic book reader with high contrast can be provided.

In the case of using a transflective liquid crystal display device as the display portion 881, the electronic book reader may be used in a comparatively bright environment; in that case, with the structure shown in FIG. 34A, power generation by the solar cell 883 and charge by the battery 885 can be effectively performed, which is preferable. Further, the solar cell 883 can be provided on a space (a surface or a rear surface) of the housing 880 as appropriate, whereby the battery 885 can be efficiently charged, which is preferable. As for the battery 885, a lithium ion battery provides a merit such as downsizing.

The structure and the operation of the charge/discharge control circuit 884 illustrated in FIG. 34A are described using a block diagram in FIG. 34B. FIG. 34B illustrates the solar cell 883, the battery 885, the converter 886, a converter 887, switches SW1 to SW3, and the display portion 881. The battery 885, the converter 886, the converter 887, and the switches SW1 to SW3 correspond to the charge/discharge control circuit 884.

First, an example of operation in the case where power is generated by the solar cell 883 using external light is described. The voltage of power generated by the solar cell is raised or lowered by the converter 886 to a voltage for charging the battery 885. When the power from the solar cell 883 is used for operation of the display portion 881, the switch SW1 is turned on and the power is raised or lowered by the converter 887 to the voltage needed for the display portion 881. On the other hand, when display on the display portion 881 is not performed, the switch SW1 is turned off and the switch SW2 is turned on, so that the battery 885 may be charged.

Next, an example of operation in the case where the solar cell 883 does not generate power by using external light is described. The voltage of power accumulated in the battery 885 is raised or lowered by the converter 887 by turning on the switch SW3. Then, power from the battery 885 is used for the operation of the display portion 881.

Although the solar cell 833 is described as an example of a means for charge, charge of the battery 885 may be performed with another means. In addition, another means for charge may be combined therewith.

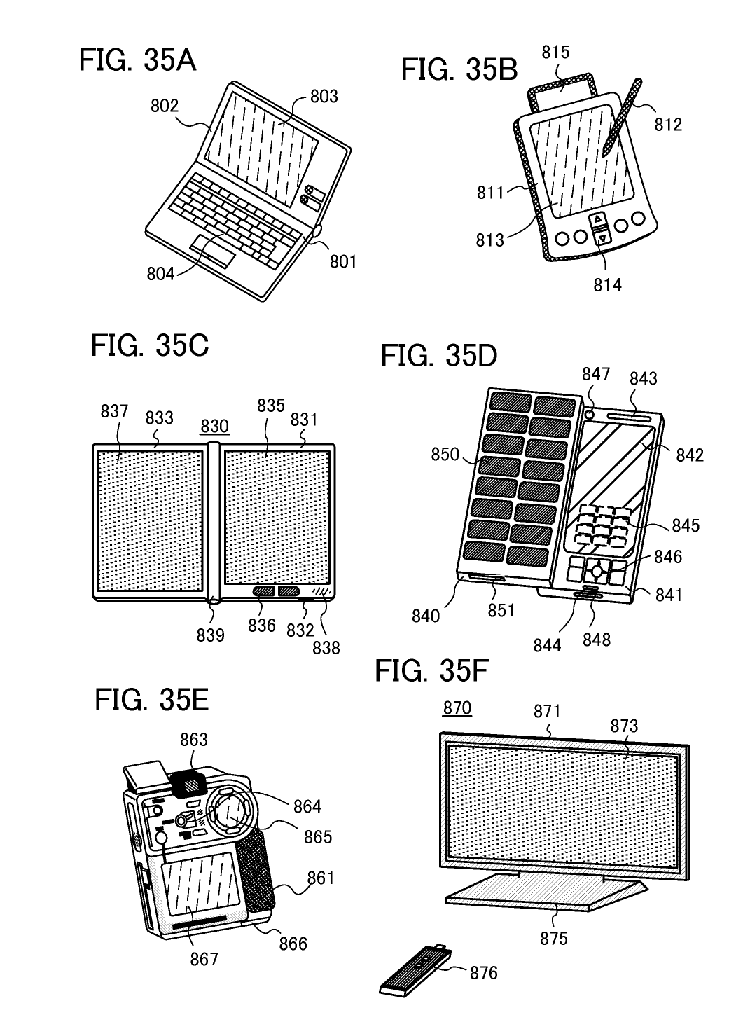

FIG. 35A illustrates a laptop personal computer which includes a main body 801, a housing 802, a display portion 803, a keyboard 804, and the like. The liquid crystal display device described in any of Embodiments 1 to 7 is applied to the display portion 803, whereby the laptop personal computer with high contrast can be provided.

FIG. 35B illustrates a portable information terminal (PDA) which includes a display portion 813, an external interface 815, an operation button 814, and the like provided for a main body 811. In addition, a stylus 812 is provided as an accessory for operation. The liquid crystal display device described in any of Embodiments 1 to 7 is applied to the display portion 813, whereby the personal digital assistant (PDA) with high contrast can be provided.

FIG. 35C illustrates an electronic book reader which is different from that shown in FIG. 34A. For example, an electronic book reader 830 includes two housings, a housing 831 and a housing 833. The housings 831 and 833 are united with an axis portion 839, along which the electronic book reader 830 can be opened and closed. With such a structure, the electronic book reader 830 can operate like a paper book.

A display portion 835 is incorporated in the housing 831, and a display portion 837 is incorporated in the housing 833. A one-page image or different images may be displayed on the display portions 835 and 837. According to the structure in which different images are displayed on the display portions, for example, text can be displayed on the display portion on the right side (the display portion 835 in FIG. 35C) and pictures can be displayed on the display portion on the left side (the display portion 837 in FIG. 35C). The liquid crystal display device described in any of Embodiments 1 to 7 is applied to the display portion 835, 837, whereby the electronic book reader 830 with high contrast can be provided.

FIG. 35C illustrates an example in which the housing 831 is provided with an operation portion and the like. For example, the housing 831 is provided with a power source 832, an operation key 836, a speaker 838, and the like. With the operation key 836, pages can be turned. A keyboard, a pointing device, or the like may be provided on the surface of the housing, where the display portion is provided. Further, an external connection terminal (an earphone terminal, a USB terminal, or the like), a recording medium insertion portion, and the like may be provided for the rear surface or the side surface of the housing. Moreover, the electronic book reader 830 may be equipped with a function of an electronic dictionary.

Further, the electronic book reader 830 may be configured to send and receive data wirelessly. Through wireless communication, book data or the like can be purchased and downloaded from an electronic book server.

FIG. 35D illustrates a mobile phone which includes two housings, a housing 840 and a housing 841. The housing 841 is provided with a display panel 842, a speaker 843, a microphone 844, a pointing device 846, a camera lens 847, an external connection terminal 848, and the like. The housing 840 is provided with a solar battery cell 850 for charging of the mobile phone, an external memory slot 851, and the like. In addition, an antenna is incorporated in the housing 841. The liquid crystal display device described in any of Embodiments 1 to 7 is applied to the display panel 842, whereby the mobile phone with high contrast can be provided.

The display panel 842 is provided with a touch panel; a plurality of operation keys 845 are depicted using dashed lines in FIG. 35D. Further, a booster circuit for raising a voltage output from the solar battery cell 850 to a voltage needed for each circuit is also equipped therewith.

In the display panel 842, the display direction can be appropriately changed depending on a usage pattern. Further, the camera lens 847 is provided on the same surface as the display panel 842, which enables a usage application as a videophone. The speaker 843 and the microphone 844 can be used for videophone calls, recording, and playing sound, and the like in addition to voice calls. Further, the housings 840 and 841 in a state where they are opened as illustrated in FIG. 35D can be slid to overlap with each other; in this manner, the size of the mobile phone can be reduced, which makes the mobile phone suitable for being carried.

The external connection terminal 848 can be connected to an AC adapter and various types of cables such as a USB cable, which enables charging and data communication with a personal computer or the like. Moreover, a storage medium can be inserted into the external memory slot 851, thereby storing and moving a larger amount of data.

In addition to the above functions, an infrared communication function, a television reception function, or the like may be equipped therewith.

FIG. 35E illustrates a digital video camera which includes a main body 861, a display portion A 867, an eyepiece 863, an operation switch 864, a display portion B 865, a battery 866, and the like. The liquid crystal display device described in any of Embodiments 1 to 7 is applied to the display portion A 867, the display portion B 865, whereby the digital video camera with high contrast can be provided.

FIG. 35F illustrates a television set. In a television set 870, a display portion 873 is incorporated in a housing 871. Images can be displayed on the display portion 873. Further, the housing 871 is supported by a stand 875 in FIG. 35F. The liquid crystal display device described in any of Embodiments 1 to 7 is applied to the display portion 873, whereby the television set with high contrast can be provided.

The television set 870 can be operated by an operation switch equipped with the housing 871 or a remote controller 876. Further, the remote controller 876 may be provided with a display portion for displaying data output from the remote controller 876.

The television set 870 is provided with a receiver, a modem, and the like. A general television broadcast can be received with the receiver. Moreover, connection to a communication network with or without wires via the modem enables one-way (from sender to receiver) or two-way (between sender and receiver or between receivers) data communication.

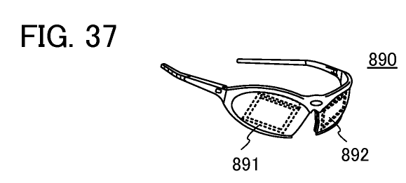

FIG. 37 illustrates liquid crystal shutter glasses. Liquid crystal shutter glasses 890 illustrated in FIG. 37 includes a right-eye liquid crystal shutter 891 and a left-eye liquid crystal shutter 892 in regions corresponding to lens for glasses. The right-eye liquid crystal shutter 891 and the left-eye liquid crystal shutter 892 are each electrically connected to a driving unit (not shown).

With the driving unit, a voltage which is equal to or higher than the threshold voltage is applied to the right-eye liquid crystal shutter 891 and the left-eye liquid crystal shutter 892 at constant intervals so that an “open state” where the light transmittance is high and a “close state” where the light transmittance is low appear alternately.

The driving unit can control the liquid crystal shutter glasses 890 in synchronization with an image display device where an image for the right eye and an image for the left eye are displayed alternately such that the left-eye liquid crystal shutter 892 comes into the “open state” and the right-eye liquid crystal shutter 891 comes into the “close state” when the image for the left eye is displayed in the image display device whereas the left-eye liquid crystal shutter 892 comes into the “close state” and the right-eye liquid crystal shutter 891 comes into the “open state” when the image for the right eye is displayed in the image display device.

According to such an operation, only the image for the left eye and the image for the right eye enter the left eye and the right eye, respectively of a viewer wearing the liquid crystal shutter glasses 890 and watching the image display device. Then, the image for the left eye and the image for the right eye are combined in the brain of the viewer, which enables an image displayed in the image display device to be recognized in three dimensions.

The liquid crystal display device described in any of Embodiments 1 to 7 can be applied as a liquid crystal shutter to each of the right-eye liquid crystal shutter 891 and the left-eye liquid crystal shutter 892, whereby the liquid crystal shutter glasses with high contrast can be provided.

This embodiment can be implemented in appropriate combination with the structures described in the other embodiments.

### EXPLANATION OF REFERENCE

401: gate wiring layer; 402: semiconductor layer; 403: wiring layer; 404: wiring layer; 405: pixel electrode; 406: common electrode; 407: convex structural body; 408: convex structural body; 409: capacitor wiring layer; 410: opening; 415: pixel electrode; 416: common electrode; 420: transistor; 425: pixel electrode; 426: common electrode; 427: convex structural body; 428: convex structural body; 430: transistor; 433a: polarizing plate; 433b: polarizing plate; 435: pixel electrode; 436: common electrode; 441: substrate; 442: substrate; 443: gate insulating layer; 444: insulating film; 445: insulating film; 446: insulating layer; 447: liquid crystal layer; 448: conductive film; 457: convex structural body; 458: convex structural body; 467: convex structural body; 468: convex structural body; 475: pixel electrode; 476: common electrode; 477: convex structural body; 478: convex structural body; 485: pixel electrode; 486: common electrode; 487: convex structural body; 488: convex structural body; 495: pixel electrode; 496: common electrode; 497: convex structural body; 498: convex structural body; 505: pixel electrode; 506: common electrode; 507: convex structural body; 508: convex structural body; 515: pixel electrode; 516: common electrode; 517: convex structural body; 525: pixel electrode; 526: common electrode; 527: convex structural body; 528: convex structural body; 535: pixel electrode; 536: common electrode; 545: pixel electrode; 546: common electrode; 547: convex structural body; 548: convex structural body; 555: pixel electrode; 556: common electrode; 557: convex structural body; 565: pixel electrode; 566: common electrode; 568: convex structural body; 575: pixel electrode; 576: common electrode; 605: pixel electrode; 606: common electrode; 607: convex structural body; 608: convex structural body; 615: pixel electrode; 616: common electrode; 617: convex structural body; 618: convex structural body; 625: pixel electrode; 626: common electrode; 627: convex structural body; 628: convex structural body; 635: pixel electrode; 636: common electrode; 637: convex structural body; 638: convex structural body; 645: pixel electrode; 646: common electrode; 647: convex structural body; 648: convex structural body; 655: pixel electrode; 656: common electrode; 657: convex structural body; 658: convex structural body; 665: pixel electrode; 666: common electrode; 667: convex structural body; 668: convex structural body; 675: pixel electrode; 676: common electrode; 677: convex structural body; 678: convex structural body; 702: pixel portion; 703: signal line driver circuit; 703a: signal line driver circuit; 703b: signal line driver circuit; 704: scan line driver circuit; 705: sealant; 714: light-blocking layer; 715: connection terminal electrode; 716: terminal electrode; 718: FPC; 719: anisotropic conductive film; 720: liquid crystal display panel; 730: backlight portion; 732: backlight; 733: light-emitting element; 733B: LED; 733G: LED; 733R: LED; 734: diffusion plate; 735: light; 790: liquid crystal display module; 801: main body; 802: housing; 803: display portion; 804: keyboard; 811: main body; 812: stylus; 813: display portion; 814: an operation button; 815: external interface; 830: electronic book reader; 831: housing; 832: power source; 833: housing; 835: display portion; 836: operation key; 837: display portion; 838: speaker; 839: axis portion; 840: housing; 841: housing; 842: display panel; 843: speaker; 844: microphone; 845: operation key; 846: pointing device; 847: camera lens; 848: external connection terminal; 850: solar battery cell; 851: external memory slot; 861: main body; 863: eyepiece; 864: operation switch; 865: display portion B; 866: battery; 867: display portion A; 870: television set; 871: housing; 873: display portion; 875: stand; 876: remote controller; 880: housing; 881: display portion; 882: operation key; 883: solar battery cell; 884: charge/discharge control circuit; 885: battery; 886: converter; 887: converter; 890: liquid crystal shutter glasses; 891: right-eye liquid crystal shutter; 892: left-eye liquid crystal shutter; 901: rising time; 902: falling time; 903: rising time; 904: falling time.

This application is based on Japanese Patent Application serial no. 2010-267596 filed with Japan Patent Office on Nov. 30, 2010, the entire contents of which are hereby incorporated by reference.

1. A liquid crystal display device comprising:
a first substrate and a second substrate with a liquid crystal layer provided therebetween;
a transistor, a first pixel electrode, and a first common electrode which are provided over the first substrate; and
a second pixel electrode and a second common electrode which are provided on the second substrate,
wherein the first pixel electrode is electrically connected to the transistor and the second pixel electrode.

2. The liquid crystal display device according to claim 1, wherein the first pixel electrode, the second pixel electrode, the first common electrode, and the second common electrode have a region having a comb-like shape.

3. The liquid crystal display device according to claim 1, wherein the first common electrode is electrically connected to the second common electrode.

4. A liquid crystal display device comprising:
a first substrate and a second substrate with a liquid crystal layer exhibiting a blue phase provided therebetween;
a transistor, a first pixel electrode, and a first common electrode which are provided over the first substrate; and
a second pixel electrode and a second common electrode which are provided on the second substrate,
wherein the first pixel electrode is electrically connected to the transistor and the second pixel electrode.

5. The liquid crystal display device according to claim 4, wherein the first pixel electrode, the second pixel electrode, the first common electrode, and the second common electrode have a region having a comb-like shape.

6. The liquid crystal display device according to claim 4, wherein the first common electrode is electrically connected to the second common electrode.

7. A liquid crystal display device comprising:
a first substrate and a second substrate with a liquid crystal layer provided therebetween;
a transistor, a first pixel electrode, and a first common electrode which are provided over the first substrate; and
a second pixel electrode and a second common electrode which are provided on the second substrate,
wherein the first pixel electrode is electrically connected to the transistor and the second pixel electrode,
wherein a structural body is provided on the first substrate or the second substrate, and
wherein the first pixel electrode and the second pixel electrode are electrically connected over the structural body.

8. The liquid crystal display device according to claim 7, wherein the first pixel electrode, the second pixel electrode, the first common electrode, and the second common electrode have a region having a comb-like shape.

9. The liquid crystal display device according to claim 7, wherein the first common electrode is electrically connected to the second common electrode.

10. The liquid crystal display device according to claim 7, wherein the structural body has a convex shape.

11. The liquid crystal display device according to claim 7, wherein the structural body is an insulator.

12. The liquid crystal display device according to claim 7, further comprising a light-blocking layer over the first substrate,
wherein the structural body overlaps with the light-blocking layer.

13. The liquid crystal display device according to claim 8, wherein the structural body extends in a direction in which the region having the comb-like shape extends.

14. A liquid crystal display device comprising:
a first substrate and a second substrate with a liquid crystal layer exhibiting a blue phase provided therebetween;
a transistor, a first pixel electrode, and a first common electrode which are provided over the first substrate; and
a second pixel electrode and a second common electrode which are provided on the second substrate,
wherein the first pixel electrode is electrically connected to the transistor and the second pixel electrode,
wherein a structural body is provided on the first substrate or the second substrate, and
wherein the first pixel electrode and the second pixel electrode are electrically connected over the structural body.

15. The liquid crystal display device according to claim 14, wherein the first pixel electrode, the second pixel electrode, the first common electrode, and the second common electrode have a region having a comb-like shape.

16. The liquid crystal display device according to claim 14, wherein the first common electrode is electrically connected to the second common electrode.

17. The liquid crystal display device according to claim 14, wherein the structural body has a convex shape.

18. The liquid crystal display device according to claim 14, wherein the structural body is an insulator.

19. The liquid crystal display device according to claim 14, further comprising a light-blocking layer over the first substrate,
wherein the structural body overlaps with the light-blocking layer.

20. The liquid crystal display device according to claim 15, wherein the structural body extends in a direction in which the region having the comb-like shape extends.

21. A liquid crystal display device comprising:
a first substrate and a second substrate with a liquid crystal layer provided therebetween;
a transistor, a first pixel electrode, and a first common electrode which are provided over the first substrate; and
a second pixel electrode and a second common electrode which are provided on the second substrate,
wherein the first pixel electrode is electrically connected to the transistor and the second pixel electrode,
wherein a structural body is provided on the first substrate or the second substrate, and
wherein the first common electrode and the second common electrode are electrically connected over the structural body.

22. The liquid crystal display device according to claim 21, wherein the first pixel electrode, the second pixel electrode, the first common electrode, and the second common electrode have a region having a comb-like shape.

23. The liquid crystal display device according to claim 21, wherein the structural body has a convex shape.

24. The liquid crystal display device according to claim 21, wherein the structural body is an insulator.

25. The liquid crystal display device according to claim 21, further comprising a light-blocking layer over the first substrate,
wherein the structural body overlaps with the light-blocking layer.

26. The liquid crystal display device according to claim 22, wherein the structural body extends in a direction in which the region having the comb-like shape extends.

27. A liquid crystal display device comprising:
a first substrate and a second substrate with a liquid crystal layer exhibiting a blue phase provided therebetween;
a transistor, a first pixel electrode, and a first common electrode which are provided over the first substrate; and
a second pixel electrode and a second common electrode which are provided on the second substrate,
wherein the first pixel electrode is electrically connected to the transistor and the second pixel electrode,
wherein a structural body is provided on the first substrate or the second substrate, and
wherein the first common electrode and the second common electrode are electrically connected over the structural body.

28. The liquid crystal display device according to claim 27, wherein the first pixel electrode, the second pixel electrode, the first common electrode, and the second common electrode have a region having a comb-like shape.

29. The liquid crystal display device according to claim 27, wherein the structural body has a convex shape.

30. The liquid crystal display device according to claim 27, wherein the structural body is an insulator.

31. The liquid crystal display device according to claim 27, further comprising a light-blocking layer over the first substrate,
wherein the structural body overlaps with the light-blocking layer.

32. The liquid crystal display device according to claim 28, wherein the structural body extends in a direction in which the region having the comb-like shape extends.
